(19) United States
(12) Patent Application Publication
(10) Pub. No.: US 2024/0126485 A1
(43) Pub. Date: Apr. 18, 2024

(54) CONTROLLING APPARATUS, CONTROL METHOD, AND NON-TRANSITORY COMPUTER-READABLE STORAGE MEDIUM STORING PROGRAM

(71) Applicant: CANON KABUSHIKI KAISHA, Tokyo (JP)

(72) Inventors: Kazuo Wakai, Tokyo (JP); Kosuke Tsujita, Tokyo (JP); Shogo Higashi, Kanagawa (JP); Yoshiji Kanamoto, Tokyo (JP); Koichiro Manabe, Kanagawa (JP)

(21) Appl. No.: 18/375,585

(22) Filed: Oct. 2, 2023

(30) Foreign Application Priority Data
Oct. 13, 2022 (JP) 2022-165021

(51) Int. Cl. G06F 3/12

(52) U.S. Cl. CPC G06F 3/1215; G06F 3/1263; G06F 3/1297

(57) ABSTRACT

A controlling apparatus includes: an acquisition unit configured to acquire sheet information of each of a plurality of pages included in job data for executing print processing in a printing apparatus; a decision unit configured to decide a print speed in the print processing based on the sheet information acquired by the acquisition unit; and a control unit configured to control the printing apparatus based on the print speed decided by the decision unit and data generated from the job data and processible by the printing apparatus. Even in a case where sheet types represented by the pieces of sheet information are mixed in the plurality of pages, the decision unit decides a print speed to be commonly applied to the sheet types of the plurality of pages.

### BACKGROUND OF THE INVENTION

### Field of the Invention

The present invention relates to a controlling apparatus that controls a plurality of print speed modes, a control method, and a non-transitory computer-readable storage medium storing a program.

### Description of the Related Art

There is conventionally known an image forming apparatus (also called a Multi Function Peripheral (MFP)) having a plurality of print speed modes. As an example, in a case of plain paper, print control in a high-speed print mode is executed. If the paper type is thick paper or coated paper, print control in a low-speed print mode is executed. The MFP supports a variety of sheet types, and can perform various kinds of print processing and working processing using the various types of sheets.

### SUMMARY OF THE INVENTION

The present invention provides a controlling apparatus that prevents print productivity from lowering due to execution of a job with a mixture of sheet types, a control method, and a non-transitory computer-readable storage medium storing a program.

The present invention in one aspect provides a controlling apparatus comprising: at least one memory and at least one processor which function as: an acquisition unit configured to acquire sheet information of each of a plurality of pages included in job data for executing print processing in a printing apparatus; a decision unit configured to decide a print speed in the print processing based on the sheet information acquired by the acquisition unit; and a control unit configured to control the printing apparatus based on the print speed decided by the decision unit and data generated from the job data and processible by the printing apparatus, wherein even in a case where sheet types represented by the pieces of sheet information are mixed in the plurality of pages, the decision unit decides a print speed to be commonly applied to the sheet types of the plurality of pages.

According to the present invention, it is possible to prevent print productivity from lowering due to execution of a job with a mixture of sheet types.

Further features of the present invention will become apparent from the following description of exemplary embodiments with reference to the attached drawings.

### BRIEF DESCRIPTION OF THE DRAWINGS

FIG. 1 is a block diagram showing a print processing system;

FIG. 2 is a block diagram showing the arrangement of an MFP;

FIG. 3 is a block diagram showing the arrangement of a DFE;

FIG. 4 is a view showing the configuration of the programs of the MFP;

FIG. 5 is a view showing the configuration of the programs of the DFE;

FIG. 6 is a table showing a medium database;

FIG. 7 is a view showing a setting screen;

FIG. 8 is a view showing a setting screen;

FIG. 9 is a view showing a setting screen;

FIG. 10 is a view showing print job data;

FIG. 11 is a table showing the print job data;

FIG. 12 is a view showing a job management screen;

FIG. 13 is a table showing job page data;

FIGS. 14A and 14B are timing charts for explaining effects in an operation according to the embodiment;

FIG. 15 is a flowchart illustrating print control processing;

FIGS. 16A and 16B are a flowchart and a view showing job data transmission processing in the DFE;

FIG. 17 is a flowchart illustrating print processing in the MFP;

FIG. 18 is a flowchart illustrating job data transmission processing in a DFE;

FIG. 19 is a flowchart illustrating print processing in an MFP;

FIG. 20 is a flowchart illustrating print control processing;

FIG. 21 is a flowchart illustrating print control processing;

FIGS. 22A and 22B are a flowchart and a view showing job data transmission processing in a DFE;

FIGS. 23A and 23B are tables each showing print job data;

FIG. 24 is a view showing a job management screen;

FIG. 25 is a table showing job page data; and

FIGS. 26A and 26B are timing charts for explaining effects in the operation according to the embodiment.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made an invention that requires all such features, and multiple such features may be combined as appropriate. Furthermore, in the attached drawings, the same reference numerals are given to the same or similar configurations, and redundant description thereof is omitted.

An image forming apparatus has a plurality of print speed modes, and selects an appropriate speed in accordance with the sheet type of a processing target and performs control. If switching of the print speed occurs, a predetermined time is required for the switching processing, and the productivity of job execution lowers.

Japanese Patent Laid-Open No. 2019-142163 describes preventing print productivity from lowering by changing the order of jobs to be processed. In Japanese Patent Laid-Open No. 2019-142163, however, a job with a mixture of sheet types is not mentioned.

According to the present disclosure, it is possible to prevent print productivity from lowering due to execution of a job with a mixture of sheet types.

### First Embodiment

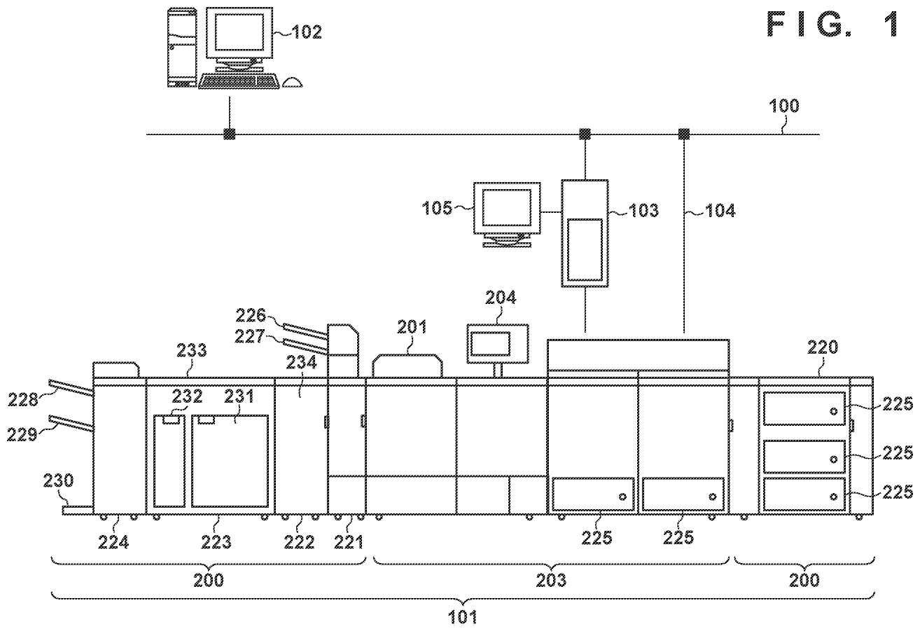

FIG. 1 is a block diagram showing an example of a print processing system according to this embodiment. In this embodiment, a Multifunction Peripheral (MFP) 101 will be described as an example of an image forming apparatus. Furthermore, a PC 102 will be described as an example of an information processing apparatus. The MFP 101 and the PC 102 are connected via a network 100 to be communicable with each other.

Note that FIG. 1 exemplifies a case where one information processing apparatus is provided in the print processing system. However, the MFP 101 and a plurality of information processing apparatuses may be connected via the network 100 to be communicable. In addition, FIG. 1 exemplifies a case where the print processing system includes an image forming apparatus and an information processing apparatus. However, the present invention is not limited to this. For example, the image forming apparatus may be the print processing system. When executing image formation processing executable by the MFP 101 alone, for example, printing of a copy job or a saving job, the information processing apparatus need not be connected to the network 100.

The PC 102 will be described first. The PC 102 can execute various kinds of programs such as an application program configured to input a print job. In addition, a printer driver that has a function of converting data into a printer description language corresponding to the MFP 101 and various kinds of applications such as workflow software are installed in the PC 102. A user who wants to print can input a print instruction from the various kinds of applications. The printer driver can convert data output from the application into data interpretable by the MFP 101 based on a print instruction, and transmit the data to the MFP 101 or a DFE 103.

Note that in this embodiment, a PC is shown as an example of the information processing apparatus. However, the information processing apparatus may be, for example, a portable information terminal such as a smartphone or a tablet terminal. Note that an arrangement for transmitting the above-described converted data to the image forming apparatus can be implemented by various methods. For example, the information processing apparatus may transmit the converted data to the image forming apparatus via a print application or a printer driver, or may transmit the converted data to the image forming apparatus via a cloud server.

The MFP 101 will be described next. The MFP 101 has a reading function of optically reading an image on an original and a print function of printing the image on a print medium such as a sheet. In addition, the MFP 101 has a post-processing function of binding a plurality of sheets with images printed thereon, aligning a plurality of sheets, or dividing the discharge destination of a plurality of sheets to a plurality of trays. Note that the sheets include paper such as plain paper, thick paper, and coated paper, and a film.

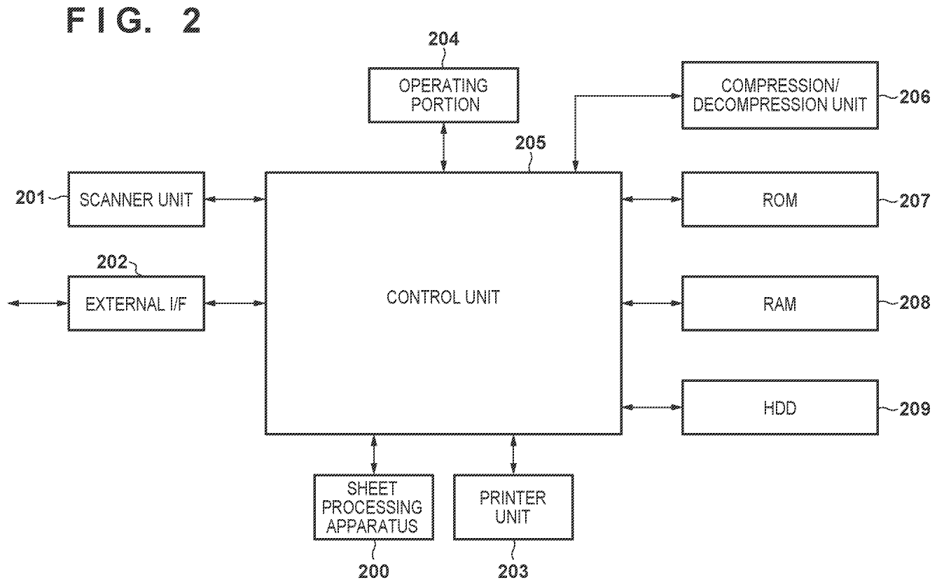

Note that in this embodiment, the MFP 101 is shown as an example of the image forming apparatus. However, the image forming apparatus may be, for example, a printer that does not have the reading function. In this embodiment, as an example, the image forming apparatus is assumed to have an arrangement shown in FIG. 2.

The Digital Front End (DFE) 103 is an apparatus that mainly performs working processing of print job data input to the MFP 101. More specifically, the DFE 103 has functions as a kind of server apparatus for performing correction and editing of print job data input from the PC 102 or the like, high-speed RIP processing, storage/management of print job data, and the like. The functions of the DFE 103 may be implemented as some of functions provided in the main body of the MFP 101. That is, the MFP 101 itself may provide the functions of the DFE 103 to an external apparatus. In this case, when viewed from the PC 102, it can be considered that the DFE 103 substitutionally provides the functions of the MFP 101 via the network 100. In the DFE 103, various kinds of input/output apparatuses that are the same as those provided in the PC 102, such as a monitor 105, may be formed. Even in this case, the MFP 101 may be directly connected to the network 100 via a network cable 104.

The MFP 101 is configured to perform various kinds of sheet processing by connecting a plurality of apparatuses having different roles to each other. Each part of the MFP 101 will be described below.

Based on image data, a printer unit 203 forms (prints) an image on a sheet fed from a paper feeding unit using toner. The arrangement and operation principle of the printer unit 203 are as follows. A light beam such as a laser beam modulated in accordance with image data is reflected by a rotating polyhedral mirror (polygon mirror or the like), and a photosensitive drum is irradiated with the reflected beam as the scan light. An electrostatic latent image formed on the photosensitive drum by the laser beam is developed by toner, and a toner image is transferred to a sheet attached to a transfer drum. The series of image forming processes is sequentially executed for yellow (Y), magenta (M), cyan (C), and black (K) toners, thereby forming a full-color image on the sheet. In addition to the four colors, a toner called a spot color or a transparent toner may be transferred. The sheet on the transfer drum, on which the full-color image is formed, is conveyed to a fixing unit. The fixing unit includes a roller and a belt, incorporates a heat source such as a halogen heater in the roller, and melts and fixes, to the sheet, the toners on the sheet with the toner image transferred thereon by heat and pressure.

According to the sheet type to be printed at the time of print processing by the MFP 101, the DFE 103 selects an appropriate print speed in printing of the printer unit 203. In this embodiment, the DFE 103 is configured to instruct the MFP 101 of the selected print speed. Since fixing processing is limited by the print speed, switching processing of the print speed is needed in accordance with the sheet type or the basis weight. More specifically, as the switching processing of the print speed, various kinds of adjustments along with the change of the print speed, such as change of the fixing temperature of an image forming unit, are executed. Note that the printer unit 203 of the MFP 101 is provided with a scanner 201 and an operation unit 204 arranged on the upper surface of the printer unit 203. The operation unit 204 provides various kinds of interface screens when the user performs various kinds of settings and operations of the printer unit 203.

A large-capacity paper feeding apparatus 220 is a paper feeding apparatus detachably attached to the printer unit 203. The paper feeding apparatus includes a plurality of paper feeding units 225. With this arrangement, the printer unit 203 can perform print processing for an enormous number of sheets. An inserter 221 is an apparatus used to insert a sheet without image formation into a product of sheets processed by the printer unit 203. FIG. 1 shows a form in which two trays 226 and 227 are provided.

A punching apparatus 222 is an apparatus aiming at performing working processing such as punching for a sheet supplied from the printer unit 203 or the inserter 221. For example, the apparatus shown in FIG. 1 is configured such that an internal component called a die can be exchanged. For this purpose, a door 234 used to exchange the die is provided.

A bookbinding apparatus 223 is an apparatus configured to execute bookbinding processing. More specifically, the bookbinding apparatus 223 is an apparatus aiming at making a binding member pass through a hole portion of a sheet that has undergone the punching by the punching apparatus 222 and then deforming the binding member, thereby obtaining a sheet bundle, that is, a bookbinding product. The created bookbinding product is stacked on a tray arranged inside a bookbinding door 231. In addition, a door 232 that can be opened/closed when replenishing binding members is formed. Furthermore, a door 233 is formed such that the user can access a sheet conveyance path in the apparatus when, for example, jam occurs in the apparatus.

A working apparatus 224 is an apparatus configured to perform staple binding for a plurality of sheet bundles. As the staple binding, binding processing in a form desired by the user, for example, corner stitching, two-spot stitching, or saddle stitching can be performed. In corner stitching or two-spot stitching, a processed product is discharged to trays 228 and 229. On the other hand, in saddle stitching, a processed product is discharged to a tray 230.

The MFP 101 can roughly be divided into three parts with respect to the printer unit 203 as the boundary. Referring to FIG. 1, a device arranged on the right side of the printer unit 203 is called a paper feeding apparatus. The paper feeding apparatus mainly continuously supplies sheets loaded inside to the printer unit 203 at an appropriate timing. The apparatus also performs detection of the remaining quantity of sheets loaded inside. The paper feeding units 225 in the printer unit 203 can execute the same function as the paper feeding apparatus. The paper feeding units provided in the printer unit 203 are also called paper feeding apparatuses for the descriptive convenience. On the other hand, referring to FIG. 1, a device arranged on the left side of the printer unit 203 is called a sheet working apparatus. This is also called a sheet processing apparatus or a post-processing apparatus. The sheet working apparatus applies various kinds of working processing for sheets that have undergone print processing, or perform processing such as accumulation. The above-described paper feeding apparatuses and the sheet working apparatus will collectively be referred to as a sheet processing apparatus 200 hereinafter.

The functional arrangement of the MFP 101 as the image forming apparatus according to this embodiment will be described next. FIG. 2 is a block diagram showing an example of the functional arrangement of the MFP 101.

The MFP 101 includes a nonvolatile memory such as a hard disk 209 (to be referred to as an HDD hereinafter) capable of storing data processible by the MFP 101. Note that in this embodiment, an example of the MFP 101 using a hard disk is shown. However, the memory is not limited to a hard disk as long as it is a large-capacity nonvolatile storage device.

Furthermore, the MFP 101 has a copy function of storing, in the HDD 209, image data received from the scanner 201, reading out the image data from the HDD 209, and printing it by the printer unit 203. The MFP 101 also has a print function of storing, in the HDD 209, job data received from an external apparatus via an external I/F 202, reading out the job data from the HDD 209, and printing it by the printer unit 203. The MFP 101 is a Multifunction Peripheral (MFP) having such a plurality of functions. Note that the print function of the MFP 101 can be any of a color print function and a monochrome print function.

The scanner 201 optically reads an original image, processes image data obtained by reading the original, and outputs the image data. The external I/F 202 transmits/receives image data and the like to/from a facsimile apparatus, a network connection device, or an external dedicated apparatus. The HDD 209 stores various kinds of management information to be stored, changed, and managed by the MFP 101 as well. The MFP 101 includes the printer unit 203 that executes print processing of job data stored in the HDD 209. The MFP 101 includes the operation unit 204 with a display unit. A controller unit (control unit) 205 provided in the MFP 101 includes a CPU (not shown), and comprehensively controls processing and operations of various kinds of units in the MFP 101. A ROM 207 stores various kinds of programs and data. For example, programs to be executed by the controller unit 205 to execute the processing of flowcharts to be described later are stored. The ROM 207 also stores a display control program configured to display, on the display unit of the operation unit 204, various kinds of UI screens including a user interface screen (to be referred to as a UI screen hereinafter).

The CPU of the controller unit 205 reads out the program stored in the ROM 207 and executes it, thereby causing the MFP 101 to execute various kinds of operations in this embodiment. In addition, the ROM 207 stores a program to be executed by the controller unit 205 to interpret and process job data received from an external apparatus via the external I/F 202. Similarly, the ROM 207 also stores a program to be executed by the controller unit 205 to perform an operation of interpreting page description language (PDL) data received from an external apparatus via the external I/F 202 and rasterizing the data into raster image data (bitmap image data). Note that PDL is an abbreviation for Print Description Language. These are processed by software. The ROM 207 is a read only memory and stores programs such as a boot sequence and font information and various kinds of programs such as the above-described programs in advance. Details of the various kinds of programs stored in the ROM 207 will be described later. A RAM 208 is a readable/writable memory and stores image data sent from the scanner 201 or the external I/F 202, various kinds of programs, setting information, and the like. Furthermore, the controller unit 205 controls the operation of the sheet processing apparatus 200. The sheet processing apparatus 200 corresponds to the paper feeding apparatuses and the sheet working apparatus described with reference to FIG. 1.

The controller unit 205 stores, in the HDD 209, job data of a processing target input via various kinds of input units such as the scanner 201 and the external I/F 202, reads out the job data from the HDD 209, and outputs the data to the printer unit 203 to cause it to execute printing. In addition, the controller unit 205 controls to transmit the job data read out from the HDD 209 to an external apparatus via the external I/F 202. Thus, the controller unit 205 can execute various kinds of output processing for job data of a processing target stored in the HDD 209. The HDD 209 also stores image data compressed by a compression/decompression unit 206. The compression/decompression unit 206 performs compression/decompression processing of image data stored in the RAM 208 or the HDD 209 using various kinds of compression methods such as JBIG and JPEG.

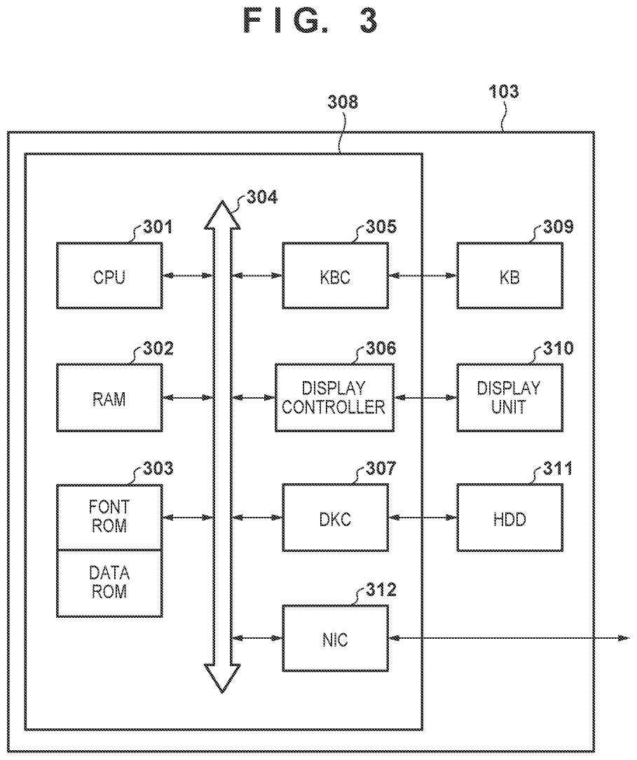

FIG. 3 is a block diagram showing an example of the arrangement of the DFE 103. Referring to FIG. 3, a CPU 301 provided in a controller unit 308 executes programs such as an OS, general applications, and bookbinding applications stored in the program ROM of a ROM 303 or loaded from an HDD 311 into a RAM 302. The ROM 303 is used as a font ROM and a data ROM. The RAM 302 functions as the main memory, work area, and the like of the CPU 301. A keyboard controller (KBC) 305 controls input from a keyboard 309 or a pointing device (not shown). A display controller 306 controls display on a display unit 310. A disk controller (DKC) 307 controls access to the HDD 311 and the like, which store a boot program, various applications, font data, and user files. A network controller (NC) 312 executes communication control processing with other devices connected to the network 100. A bus 304 connects the CPU 301 to the RAM 302, the ROM 303, various kinds of controllers, and the like, and conveys data signals and control signals.

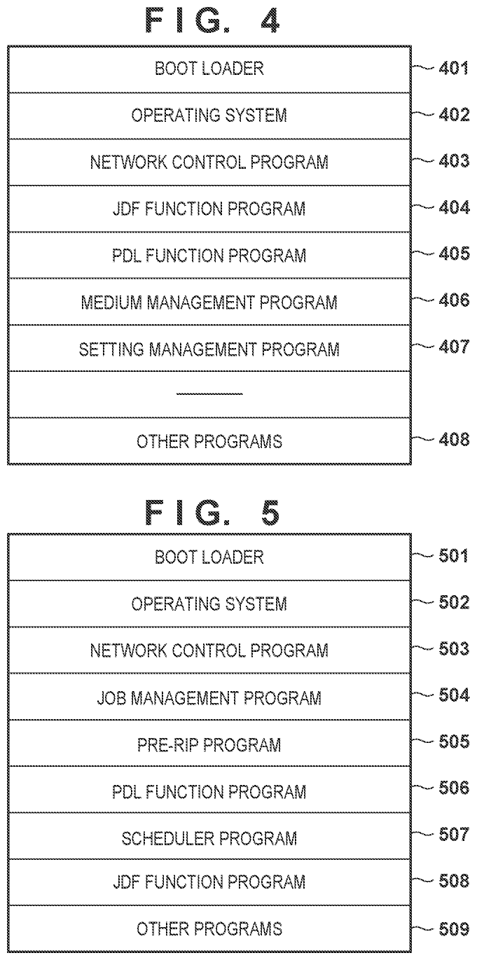

FIG. 4 is a view showing an example of the configuration of the programs of the MFP 101. The programs shown in FIG. 4 are stored in the ROM 207 and read out and executed by the controller unit 205 of the MFP 101.

A boot loader 401 is a program executed immediately after the MFP 101 is powered on. This program includes a program configured to execute various kinds of activation sequences necessary for activation of the system. An operating system 402 is a program aiming at providing an execution environment for various kinds of programs for implementing the functions of the MFP 101. This program mainly provides the functions of resource management of the memories of the MFP 101, that is, the ROM 207, the RAM 208, and the HDD 209 and basic input/output control of the units shown in FIG. 2.

A network control program 403 is a program executed when transmitting/receiving data to/from a device connected via the network. This program is used at the time of processing of receiving a file to be printed, data reception from an external apparatus, and transmission/reception of a command. The network control program includes a device driver program configured to control the external I/F 202.

A Job Definition Format (JDF) function program 404 is a program that can execute a JDF print function in a case where JDF job data is received via the external I/F 202. In the JDF print function, the controller unit 205 sequentially instructs the operations of the units shown in FIG. 2 in an appropriate order based on a processing order and processing conditions described in the JDF function program 404. As a result, control is performed to finally execute JDF print processing. Note that the units to be controlled include the sheet processing apparatus 200, the printer unit 203, the HDD 209, the compression/decompression unit 206, and the RAM 208. In addition, analysis processing of JDF job data received via the external I/F 202, processing of discriminating whether an incorrect setting is included in the JDF as the result of the analysis processing, and processing of performing setting change to eliminate the incorrect setting are executed.

A PDL function program 405 is a program that can execute PDL data expansion processing and print processing in a case where PDL data (image data of a processing target) is received via the external I/F 202. The print processing is, for example, processing for data rasterized into a raster image, and processing including generation of page image information. In the PDL function implemented by the controller unit 205, the controller unit 205 sequentially instructs the operations of the units shown in FIG. 2 in an appropriate order based on a processing order and processing conditions described in the PDL function program 405. As a result, control is performed to finally execute PDL print processing. Note that the units to be controlled include the sheet processing apparatus 200, the printer unit 203, the HDD 209, the compression/decompression unit 206, and the RAM 208. In addition, the PDL function program 405 is configured to operate together with the JDF function program 404 to analyze various kinds of job setting formats at the time of print processing execution.

A medium management program 406 is a program configured to execute a management function associated with sheets usable by the MFP 101. Sheet associated information managed by the medium management program 406 is stored in the HDD 209. The medium management program 406 provides medium management functions such as registration of a new medium and deletion of an unnecessary medium. The medium management program 406 also has a function of changing the settings of a registered medium or adjusting an unadjusted medium and reregistering it as an adjusted medium. The medium management program 406 also has a management function of exporting medium information to, for example, the PC 102 that is an external apparatus of the MFP 101 via the external I/F 202 or importing medium information from the PC 102. The sheet associated information managed by the medium management program 406 also includes the information of the print speed applicable at the time of printing.

A setting management program 407 is a program configured to do various kinds of settings of the apparatus of the MFP 101. An instruction to the setting management program 407 is input via the operation unit 204. An instruction to the setting management program 407 may be executed remotely from an external system such as the PC 102 or the DFE 103 via the external I/F 202. Other programs 408 is a generic term for programs that are not included in the above-described programs among the programs stored in the ROM 207 and executable by the MFP 101.

FIG. 5 is a view showing an example of the configuration of the programs of the DFE 103. The programs shown in FIG. 5 are stored in the ROM 303 and read out and executed by the CPU 301 of the DFE 103.

A boot loader 501 is a program executed immediately after the DFE 103 is powered on. This program includes a program configured to execute various kinds of activation sequences necessary for activation of the system. An operating system 502 is a program aiming at providing an execution environment for various kinds of programs for implementing the functions of the DFE 103. This operating system 502 provides the function of resource management of the memories of the apparatus, that is, the ROM 303, the RAM 302, and the HDD 311.

A network control program 503 is a program executed when transmitting/receiving data to/from a device connected via the network. For example, the network control program 503 is used when transmitting job data to the MFP 101 and instructing print processing. In addition, the network control program 503 is used to receive, from an external apparatus such as the PC 102, print job data to be used for printing, or transmit status information.

A job management program 504 is a program configured to manage job data for each job transmitted from the DFE 103 to the MFP 101. The job management program 504 can manage a job list in the order of transmission and execute processing such as change of the job order, and pause of a job, cancel, and setting change. If the DFE 103 receives print job data from the PC 102 that is an external apparatus, the job management program 504 operates in cooperation with a PDL function program 506, a scheduler program 507, and a Pre-RIP program 505 to be described later. Then, a series of job management and job execution control as the DFE 103 is performed.

The Pre-RIP program 505 is a program configured to, when the DFE 103 receives print job data from the PC 102 via the network control program 503, analyze the structure information (configuration information) of the received print job data. More specifically, the Pre-RIP program 505 collects the number of pages and the page size of print job data, sheet information of each page, and various kinds of setting information and transmits these to the job management program 504.

The PDL function program 506 is a program configured to execute print job data expansion processing that is executed when the DFE 103 receives print job data from the PC 102 via the network control program 503. The print job data is converted into a format suitable for printing (a format processible by the MFP 101) and transmitted to the MFP 101 via the network control program 503. Thus, the MFP 101 is instructed to execute print processing.

The Pre-RIP program 505 and the PDL function program 506 are synchronized with the medium management program 406 of the MFP 101 by the network control program 503. The Pre-RIP program 505 and the PDL function program 506 are configured to discriminate the type of a medium and print conditions to be used in print processing of a job and execute selection and control of an appropriate print speed. Details of selection and control of the print speed will be described later.

The scheduler program 507 is a program aiming at presenting information about the progress state of each of a plurality of jobs registered in the job management program 504. The required time of a job or a time when paper will run out can be displayed on the display unit 310 in time series. Hence, the user of the MFP 101 and the DFE 103 can efficiently execute paper replenishment and can also make a production plan and execute generation of a product. Other programs 509 is a generic term for programs that are not included in the above-described programs among the programs provided in the DFE 103.

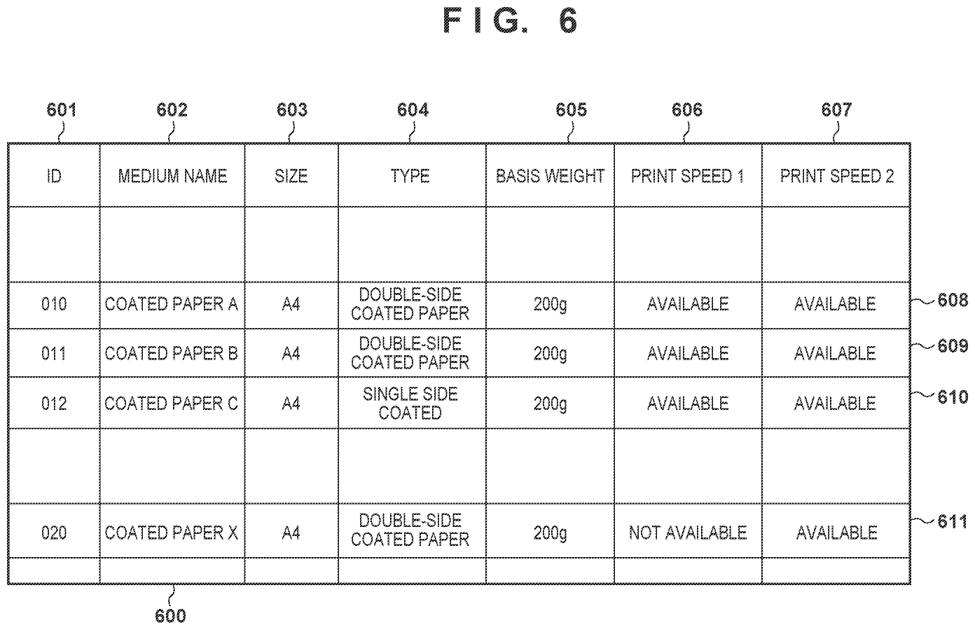

FIG. 6 is a table showing an example of a medium database managed by the medium management program 406 shown in FIG. 4 and stored in the HDD 209. Information stored and managed in the medium database can also be referred to and edited from the DFE 103 via the network control program 503.

An ID field 601 in FIG. 6 is an internal ID that is uniquely decided in the MFP 101 concerning all medium entries stored in the medium database. A medium name field 602, a medium size field 603, a medium type field 604, and a basis weight field 605 are medium associated parameters of the medium database.

A print speed field 606 indicates applicability of a print speed (print speed 1) in a high-speed print mode of a plurality of print speed modes provided in the MFP 101. A print speed field 607 indicates applicability of a print speed (print speed 2) in a low-speed print mode of the plurality of print speed modes provided in the MFP 101. Based on the information stored in the print speed field 606 and the print speed field 607, executability of print processing at each print speed is determined for each medium managed by the medium database. Note that the information stored in the print speed field 606 and the print speed field 607 may be edited or created by the operator of the MFP 101. Alternatively, the provider (manufacturer) of the MFP 101 may permanently provide the information as a part of product specifications to the operator.

FIG. 6 shows detailed cases of four registered sheets. More specifically, as shown in FIG. 6, coated paper A 608, coated paper B 609, coated paper C 610, and coated paper X 611 are exemplified. FIG. 6 shows an example in which the medium size field 603, the medium type field 604, and the basis weight field 605 hold the same values for the coated paper A 608, the coated paper B 609, and the coated paper X 611. In other words, for the MFP 101, the three media shown in FIG. 6 are equivalent in terms of characteristics.

In this embodiment, values in the print speed field 606 and the print speed field 607 in FIG. 6 are determined. In the example shown in FIG. 6, it is determined that print speed 2 can be applied to all the coated paper A 608, the coated paper B 609, the coated paper C 610, and the coated paper X 611. On the other hand, as for print speed 1, it is determined that print speed 1 can be applied to the coated paper A 608, the coated paper B 609, and the coated paper C 610 but not to the coated paper X 611.

Even if the medium size field 603 to the basis weight field 605 have the same values for a plurality of medium types, an applicable print speed may be different. In this embodiment, when executing a print job with a mixture of medium types, it is possible to eliminate switching of the print speed and suppress lowering of print productivity by decision control of the print speed.

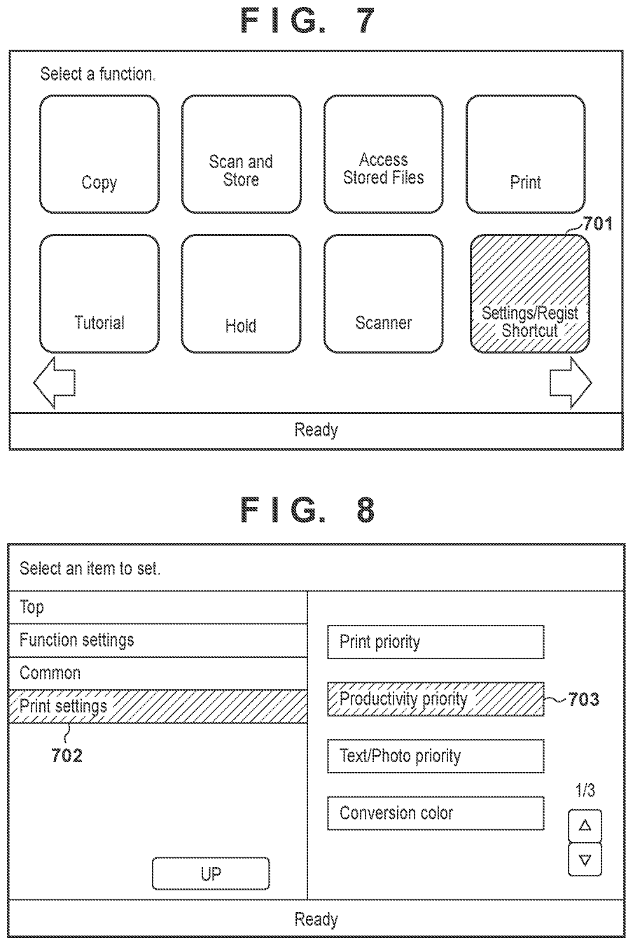

FIGS. 7, 8, and 9 are views showing examples of a print speed mode setting screen displayed on the operation unit 204 of the MFP 101.

FIG. 7 shows an example of a basic screen displayed on the operation unit 204 of the MFP 101. As shown in FIG. 4, the MFP 101 includes various kinds of programs. FIG. 7 shows a state in which a setting portion 701 is selected. The setting portion 701 is an item provided to set various kinds of default operations and the management function of the MFP 101, and is an item used to instruct execution of the setting management program 407.

FIG. 8 is a view showing an example of setting items to transition after the setting portion 701 is selected. The transition to the screen shown in FIG. 8 and display processing of various kinds of setting instructions are implemented by the controller unit 205 executing the setting management program 407. FIG. 8 shows a state in which a print setting portion 702 is selected. In addition, FIG. 8 shows a state in which a productivity setting portion 703 is selected as an example of detailed items of the print setting portion 702.

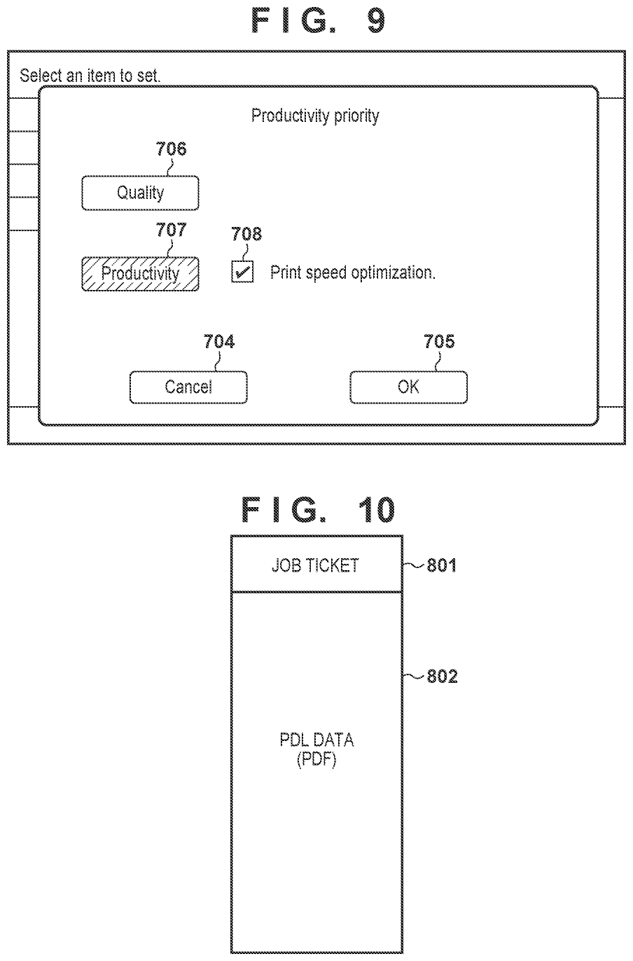

FIG. 9 is a view showing an example of a screen to transition after the productivity setting portion 703 is selected. When the selection of a quality designation portion 706 is accepted, a print speed mode of the lowest speed is selected, from at least one or more print speed modes, as a print speed mode to be applied in print processing of a sheet, and applied at the time of print processing. That is, print processing is executed in a quality priority mode. When the selection of a productivity designation portion 707 is accepted, a print speed mode of the highest speed is selected, from at least one or more print speed modes, as a print speed mode to be applied in print processing of a sheet, and applied at the time of print processing. That is, print processing is executed in a productivity priority mode.

An optimization designation portion 708 is selected as a predetermined mode when executing optimization processing of the print speed in a state in which the productivity designation portion 707 is selected. In the optimization processing of the print speed, if it is determined that switching of the print speed mode is necessary, the optimum print speed is automatically decided to suppress lowering of productivity caused by the occurrence of switching of the print speed.

An OK button 705 is used to instruct storage of set contents in FIGS. 7, 8, and 9 in the HDD 209. A cancel button 704 is used to cancel the set contents in FIGS. 7, 8, and 9, and end the setting operation without storing the set contents in the HDD 209.

The optimization designation portion 708 may be set by the DFE 103. Even if the optimization designation portion 708 is set by the MFP 101, the DFE 103 may acquire the set value of the optimization designation portion 708 via the network controller (NC) 312 and the external I/F 202 of the MFP 101.

In this embodiment, if the optimization designation portion 708 is selected by the user, the DFE 103 and the MFP 101 execute control to be described below.

When print job data is received from the PC 102 via the network control program 503, the DFE 103 analyzes, by the Pre-RIP program 505, the structure information of the received print job data. The DFE 103 collects, by the Pre-RIP program 505, the number of pages and the page size of the print job data, sheet information of each page, and various kinds of setting information. The DFE 103 performs, by the PDL function program 506, expansion processing of the print job data. Then, the DFE 103 instructs the MFP 101 to execute print processing by converting the data into a data format suitable for printing and transmitting the data to the MFP 101 via the network control program 503.

Upon receiving job data, the MFP 101 expands the job data to generate information of a page image that is a target of print processing. This operation is implemented when the controller unit 205 reads out and executes the PDL function program 405. At the same time as the generation of the page image information, the sheet information of sheets to be used in printing is confirmed based on the result of the expansion processing. The expansion processing is sequentially executed from the top page of the data forming the job. Then, printable page image data is stored in the HDD 209 of the MFP 101. Conventionally, for the page image data stored in the HDD 209, print processing is quickly executed by the PDL function program 405 and the controller unit 205 in the MFP. At this time, the print speed mode to be applied at the time of printing is selected out of print speed 1 in the field 606 and print speed 2 in the field 607, which are stored in the medium database shown in FIG. 6 managed by the medium management program 406 based on the confirmed sheet information.

However, if sheet types are mixed in the job data, and the print speed modes are mixed because sheets cannot be processed at a single print speed, switching processing of the print speed is needed. As a result, production is temporarily interrupted such that the MFP 101 performs switching processing of the print speed at the boundary of pages of different sheet types, thereby lowering productivity.

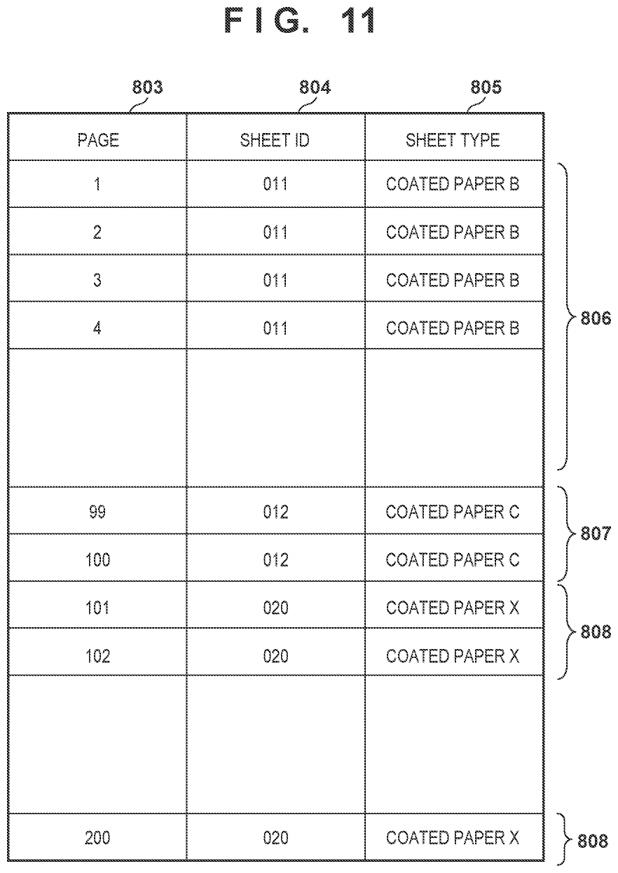

FIGS. 10 and 11 are a view and a table showing an example of print job data. FIG. 10 is a view showing an example of the overall structure of print job data. The print job data shown in FIG. 11 is created by various kinds of applications operating in the PC 102 or the like for the purpose of being processed by the PDL function program 405. As shown in FIG. 10, the print job data is formed from a plurality of subdivided data, and these subdivided data are transmitted in a composed state from the PC 102 or the like to the DFE 103.

A job ticket portion 801 is a data portion that stores print settings. In the example shown in FIG. 10, the job ticket portion 801 includes setting information applied to the entire print job and the settings of various kinds of post-processing and image processing. In some cases, the job ticket portion 801 includes sheet setting information of each page.

A PDL data portion 802 is a data portion that stores image information forming each page and various kinds of print control commands. In the example shown in FIG. 10, an example of a data portion formed by the PDF format is assumed. However, the data portion may be formed by another page description language such as Postscript.

In this embodiment, the PDL data portion 802 is expanded, thereby acquiring medium information to be used for print processing of each of a plurality of pages. In other words, medium information to be used for print processing of each page is stored in the PDL data portion 802, and these pieces of information are acquired by expanding the PDL data portion 802. However, the medium information may be acquired in the job ticket portion 801.

FIG. 11 is a view showing an example of medium information (sheet information) for each page, which is acquired by expanding the PDL data portion 802 shown in FIG. 10 and used at the time of printing in the job. The information shown in FIG. 11 is extracted as the result of analyzing the PDL data portion 802 shown in FIG. 10. The DFE 103 sets, based on the information shown in FIG. 11, sheet information as a print target for each of the pages forming the job, and executes a print instruction to the MFP 101. Upon receiving the print instruction, the controller unit 205 of the MFP 101 controls to select and feed an appropriate sheet from one of the paper feeding units 225 shown in FIG. 1.

A page field 803 indicates page numbers in the print job data shown in FIG. 10. A sheet ID field 804 and a sheet type field 805 are fields that are set for the purpose of being used when printing page data indicated in the page field 803 and store the sheet information acquired after the expansion of the PDL data portion 802.

FIG. 11 shows an example of print job data in which a mixture of sheet types is set. That is, a medium 806 for which the sheet ID is “011” and the sheet type is “coated paper B” is set for pages 1 to 98. Similarly, a medium 807 for which the sheet ID is “012” and the sheet type is “coated paper C” is set for pages 99 and 100. A medium 808 for which the sheet ID is “020” and the sheet type is “coated paper X” is set for pages 101 to 200.

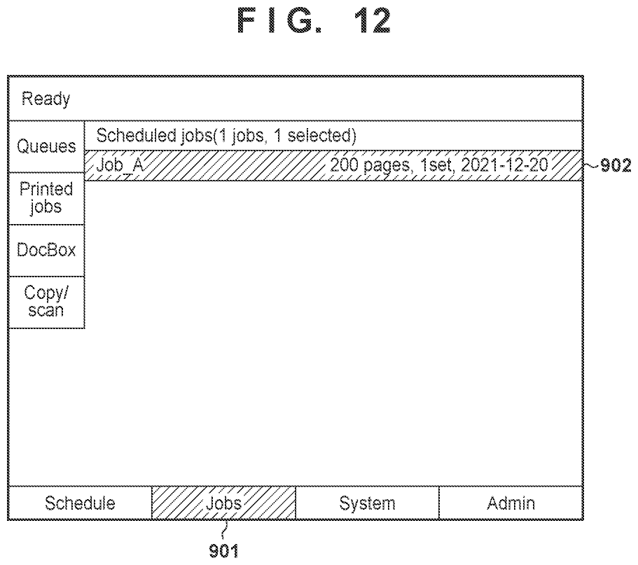

FIG. 12 is a view showing an example of a job management screen displayed on the monitor 105 (or the display unit 310) provided in the DFE 103. FIG. 12 shows a state in which Job_A 902 is registered in the DFE 103 in a state in which a job management screen selection portion 901 is selected. Note that if a plurality of jobs are registered in the DFE 103, the plurality of jobs are displayed on the job management screen shown in FIG. 12. The Job_A 902 is, for example, a job transmitted from the PC 102 to the DFE 103. When the DFE 103 receives the job data, it executes print speed determination processing to be described later, and then transmits the job data to the connected MFP 101.

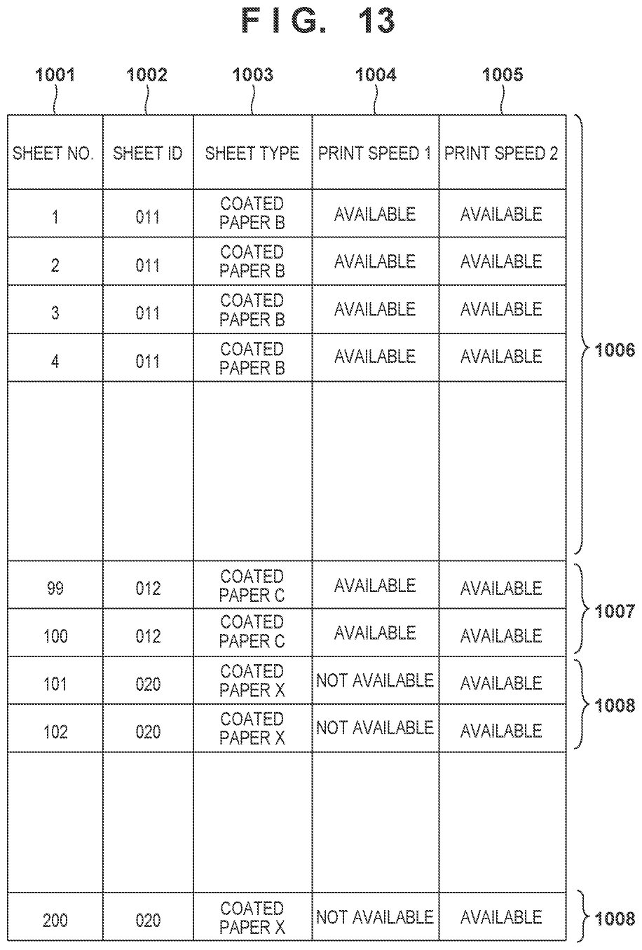

FIG. 13 is a table showing an example of job page data (sheet use information) generated and managed in the DFE 103 when the DFE 103 receives the Job_A 902 shown in FIG. 12, and determines a print speed to be applied at the time of printing. The job page data is formed from a plurality of fields to be described below. The information shown in FIG. 13 can be obtained when the DFE 103 receives and analyzes, by the network control program 503, the information of the medium database shown in FIG. 6 managed by the medium management program 406 of the MFP 101.

For each page indicated by a page field 1001, sheet information used at the time of printing is indicated by a sheet ID field 1002 and a sheet type field 1003. Furthermore, a print speed field 1004 and a print speed field 1005 indicate applicability of print speed 1 in the high-speed print mode and print speed 2 in the low-speed print mode, respectively, for a sheet used at the time of printing each page.

As shown in FIG. 13, values in the print speed field 1004 and the print speed field 1005 are “available” for pages 1 to 100. On the other hand, the value in the print speed field 1004 is “not available” and the value in the print speed field 1005 is “available” for pages 101 to 200.

That is, if the DFE 103 receives the print job data shown in FIG. 10, it is determined that the sheet type selected at the time of printing the print job data includes a sheet printable only at print speed 2. In other words, it is determined that print processing at print speed 1 in the high-speed print mode can be performed for pages 1 to 100. However, when printing sheets for pages 101 to 200, it is necessary to execute printing only at print speed 2 in the low-speed print mode. Therefore, switching of the print speed from print speed 1 to print speed 2 occurs, and the switching time is added to the print processing time.

In this embodiment, it is possible to suppress lowering of productivity caused by the occurrence of the switching time by performing the following processing.

In this embodiment, as an example, assume that a print sheet size designated by the print job is A4, and print speed 1 in the high-speed print mode of the print speed modes of the MFP 101 is 100 PPM. Note that PPM is an abbreviation for Page Per Minutes, and indicates the number of pages printable per min. Assume that print speed 2 in the low-speed print mode is 75 PPM. It takes 30 sec to switch between print speed 1 and print speed 2. The total number of pages of the print job data is 200, as shown in FIGS. 10 and 11, and the number of print sheets is 200.

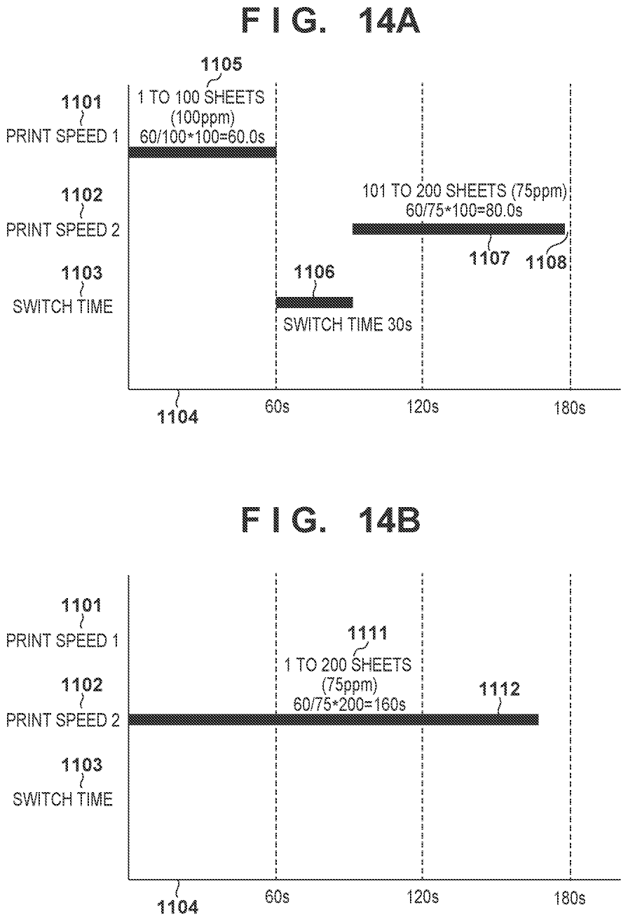

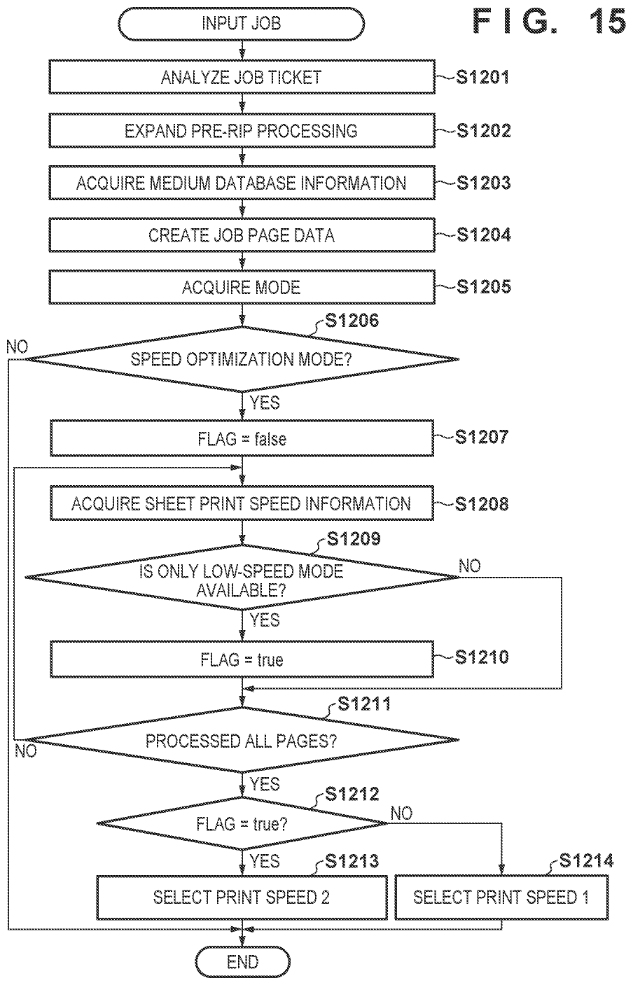

FIGS. 14A and 14B are timing charts for explaining effects in the operation according to this embodiment. Hereinafter, as an example, FIGS. 14A and 14B will be described below concerning a case where the above conditions are used.

FIG. 14A shows required times at print speeds applied to pages at the time of printing and a switching time in a case where switching of the print speed occurs when the MFP 101 executes conventional print processing using the above conditions. The ordinate represents the required time at a print speed 1101 (print speed 1), the required time at a print speed 1102 (print speed 2), and a switching time 1103. An abscissa 1104 represents accumulation of required times from the start of processing.

As shown in FIG. 14A, media for which print processing at print speed 1 can be performed are used for pages 1 to 100 of the print job data. Processing is performed in the high-speed print mode at 100 PPM, and a required time 1105 is 60.0 sec. On the other hand, for the media of pages 101 to 200, print processing at print speed 1 cannot be performed, and only print processing at print speed 2 can be performed. For this reason, switching of the print speed occurs, and a switching time 1106 of 30.0 sec is required. After the switching processing is ended, print processing of pages from the 101st page is executed, and a required time 1107 is 80.0 sec. Thus, a cumulative time 1108 is 170.0 sec.

FIG. 14B shows required times at print speeds applied to pages at the time of printing and a switching time in a case where switching of the print speed occurs when the MFP 101 executes print processing using the above conditions according to this embodiment. If all the sheets are printed commonly using print speed 2 as the print speed to be applied at the time of printing in order to suppress the occurrence of a switching time of the print speed mode, a required time 1111 is 160.0 sec. Thus, a cumulative time 1112 is 160.0 sec. As a result, with respect to the print job data shown in FIGS. 10 and 11, the productivity is improved by 10.0 sec by suppressing the occurrence of switching of the print speed mode.

As described above, in this embodiment, the DFE 103 creates the sheet use information shown in FIG. 13, and decides the print speed not to cause switching of the print speed based on the sheet use information. Then, the DFE 103 can instruct the MFP 101 to start print processing based on the decided print speed. This can suppress lowering of productivity caused by switching of the print speed.

FIG. 15 is a flowchart illustrating print control processing according to this embodiment. The processing shown in FIG. 15 is implemented when, for example, the CPU 301 of the DFE 103 reads out the program stored in the ROM 303 into the RAM 302 and executes it. The processing shown in FIG. 15 is started when the optimization designation portion 708 shown in FIG. 9 is selected and the DFE 103 receives print job data from the PC 102 via the network control program 503.

In step S1201, upon receiving print job data, the CPU 301 analyzes the contents of the job ticket portion 801 by a JDF function program 508. Information included in the job ticket portion 801 has been described above with reference to FIG. 10.

In step S1202, the CPU 301 expands Pre-RIP processing by the Pre-RIP program 505. The Pre-RIP processing is processing of analyzing the structure information of the PDL data portion 802, and analyzing the number of pages and the sheet size of the print job data, sheet information of each page, and the like. With the Pre-RIP processing, the DFE 103 can acquire setting information applied to the entire job as a print target, the number of pages and the page size of the job data, sheet information of each page, various kinds of setting information, and the structure information of the print job data such as each post-processing. The Pre-RIP processing is executed before the start of processing for data rasterized into a raster image.

In step S1203, the CPU 301 acquires, by the Pre-RIP program 505, the information of the medium database shown in FIG. 6 from the MFP 101 via the network control program 503.

In step S1204, the CPU 301 creates, by the job management program 504, the job page data shown in FIG. 13 based on the medium information of the print job data shown in FIG. 11 and the information of the medium database shown in FIG. 6.

The job page data is created by adding, to the medium information of the print job data shown in FIG. 11, the print speed field 606 (print speed 1) and the print speed field 607 (print speed 2) in the medium database shown in FIG. 6 in linkage with the sheet ID field 804. The CPU 301 can determine the mixture state of the set contents in the print speed field 1004 (print speed 1) and the print speed field 1005 (print speed 2) from the created job page data.

In step S1205, the CPU 301 acquires, by the network control program 503, the set value of the optimization designation portion 708 set by the MFP 101. In step S1206, the CPU 301 determines, by the job management program 504, based on the set value of the optimization designation portion 708, whether a print speed optimization mode as a mode of optimizing the print speed is set.

If it is determined that the print speed optimization mode is set, the CPU 301 sets, in step S1207, the initial value of a print speed selection flag to “false”. The print speed selection flag is used for the following determination processing. For example, in a case where a given sheet can be printed at either print speed 1 in the high-speed print mode or print speed 2 in the low-speed print mode, the value of the print speed selection flag is set to “false”. On the other hand, in a case where a given sheet cannot be printed at print speed 1 in the high-speed print mode and can be printed only at print speed 2 in the low-speed print mode, the value of the print speed selection flag is set to “true”.

In step S1208, the CPU 301 pays attention to one page in the print job data, and acquires print speed information of a sheet used for the page of interest from the print speed field 1004 and the print speed field 1005 of the job page data in FIG. 13. Then, in step S1209, the CPU 301 determines whether the sheet used for the page of interest can be printed only in the low-speed print mode. For example, in step S1209, it is determined whether print speed 1 in the high-speed print mode is not available as the print speed mode applicable to the sheet used for the page of interest. If print speed 1 is not available, only print speed 2 in the low-speed print mode can be applied to the sheet used for the page of interest. Therefore, in this case, in step S1210, the CPU 301 sets the value of the print speed selection flag to “true”, and advances to step S1211. On the other hand, if it is determined that both the modes can be applied as the print speed mode applicable to the sheet used for the page of interest, the process advances from step S1209 to step S1211. In this case, the value of the print speed selection flag remains “false”.

In step S1211, the CPU 301 determines whether the processes in steps S1208 to S1210 have been executed for all the target pages of the print job data. If it is determined that the processes have not been executed for all the pages, the processes from step S1208 are repeated. If it is determined that the processes have been executed for all the pages, the CPU 301 determines in step S1212 whether the value of the print speed selection flag is “true”.

If “true” is determined, the CPU 301 selects and decides, in step S1213, print speed 2 in the low-speed print mode as the print speed to be commonly used for all the sheets of the job, and then ends the processing shown in FIG. 15. On the other hand, if “true” is not determined, that is, “false” is determined, the CPU 301 selects and decides, in step S1214, print speed 1 in the high-speed print mode as the print speed to be commonly used for all the sheets of the job, and then ends the processing shown in FIG. 15.

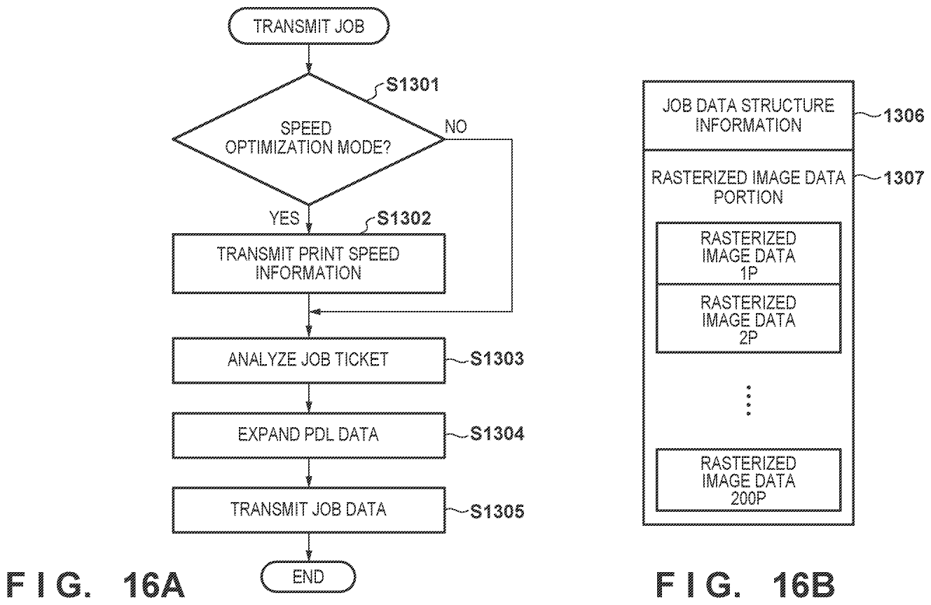

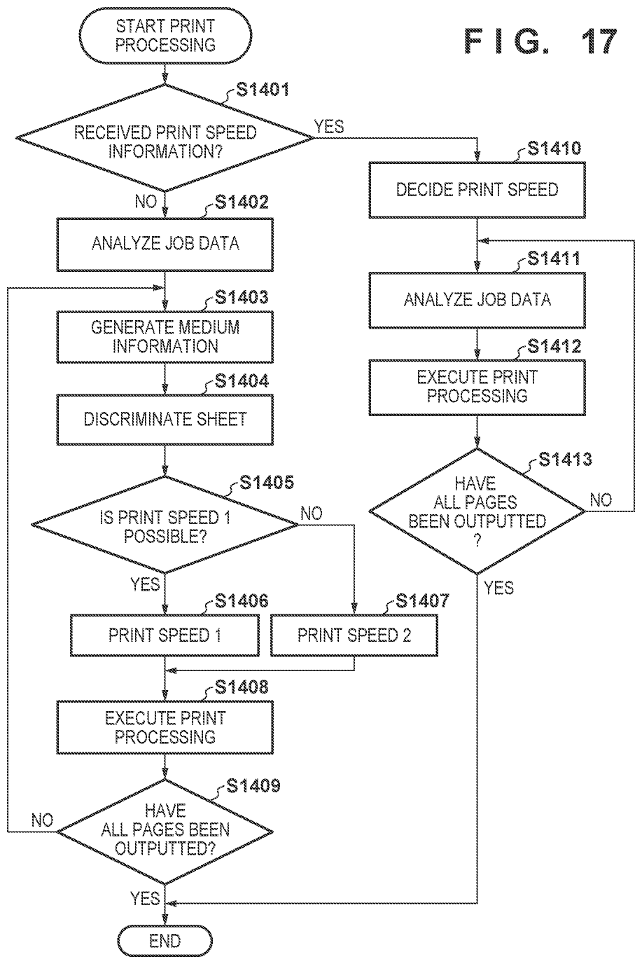

FIG. 16A is a flowchart illustrating job transmission processing in the DFE 103. The processing shown in FIG. 16A is implemented when, for example, the CPU 301 of the DFE 103 reads out the program stored in the ROM 303 into the RAM 302 and executes it. For example, FIG. 16A is executed after the processing shown in FIG. 15.

In step S1301, the CPU 301 determines, based on the set value of the optimization designation portion 708 acquired in step S1205, whether the print speed optimization mode of optimizing the print speed is set. If it is determined that the print speed optimization mode is set, the CPU 301 transmits, in step S1302, by the network control program 503, print speed information (information representing print speed 1 or print speed 2) decided in FIG. 15 to the MFP 101. Note that print speed 1 designated in the print speed information is the print speed in the high-speed print mode corresponding to the print speed field 606 in the medium database managed by the medium management program 406 of the MFP 101. Print speed 2 is the print speed in the low-speed print mode corresponding to the print speed field 607 in the medium database. After step S1302, the process advances to step S1303. If it is determined in step S1301 that the print speed optimization mode is not set, the process advances to step S1303.

In step S1303, the CPU 301 analyzes the contents of the job ticket portion 801 in the print job data. Then, the CPU 301 creates, based on the analysis result, job data structure information including setting information applied to the entire job, the number of pages and the page size of the print job data, sheet information of each page, various kinds of setting information, and information of each post-processing. Then, in step S1304, the CPU 301 starts expansion processing of the PDL data portion 802. The expansion processing in step S1304 includes processing of interpreting PDL data and rasterizing the data into a raster image.

FIG. 16B is a view showing the job data having undergone the processes in steps S1303 and S1304. The job data having undergone the processes in steps S1303 and S1304 includes job data structure information 1306 and a rasterized image data portion 1307 as rasterized image data for all the pages. In step S1305, the CPU 301 transmits, by the job management program 504, the job data shown in FIG. 16B including the job data structure information 1306 and the rasterized image data portion 1307 to the MFP 101.

Next, the operation of the MFP 101 will be described.

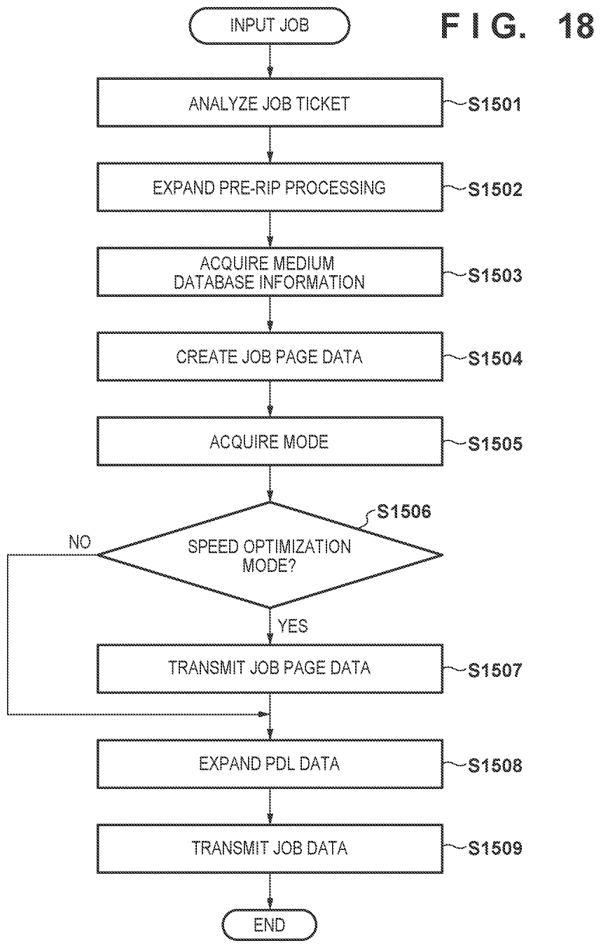

FIG. 17 is a flowchart illustrating print processing in the MFP 101. The processing shown in FIG. 17 is implemented when, for example, the controller unit 205 reads out the PDL function program 405 from the ROM 207 and executes it.

In step S1401, the controller unit 205 determines whether print speed information is received from the DFE 103. The print speed information is the print speed information transmitted from the DFE 103 in step S1302. If it is determined that the print speed information is not received, the process advances to step S1402. In processes in step S1402 and subsequent steps, the print processing shown in FIG. 14A is performed. On the other hand, if it is determined that the print speed information is received, the process advances to step S1410. In processes in step S1410 and subsequent steps, the print processing, shown in FIG. 14B, of suppressing the occurrence of switching of the print speed is performed.

First, the print processing in step S1402 and the subsequent steps will be described.

In step S1402, the controller unit 205 analyzes the job data transmitted from the DFE 103. The job data is the job data transmitted from the DFE 103 in step S1305, and includes the information shown in FIG. 16B.

In step S1403, the controller unit 205 generates, by the PDL function program 405, medium information of each page shown in FIG. 11 from the job data structure information 1306, and stores the information in the HDD 209.

In step S1404, the controller unit 205 discriminates the sheet type of the print target (the sheet type of the page of interest) based on the medium information generated in step S1403. In the discrimination processing of step S1404, the corresponding sheet type is specified from the information of the medium database shown in FIG. 6, thereby acquiring a necessary parameter set. The parameter set includes information representing applicability of each of print speed 1 and print speed 2.

In step S1405, the controller unit 205 determines whether the sheet type determined in step S1404 is a medium to which print speed 1 in the high-speed print mode can be applied. If it is determined that the sheet type is a medium to which print speed 1 can be applied, the controller unit 205 applies, in step S1406, print speed 1 in the high-speed print mode as the print speed to be applied at the time of printing the sheet of the page of interest. On the other hand, if it is determined that the sheet type is not a medium to which print speed 1 can be applied, this means that print speed 1 in the high-speed print mode cannot be applied, and only print speed 2 in the low-speed print mode can be applied. In this case, in step S1407, the controller unit 205 applies print speed 2 in the low-speed print mode as the print speed to be applied at the time of printing the sheet of the page of interest.

If the rasterized image data portion 1307 is data formed from a plurality of pages, the processes in steps S1403 to S1408 are repeated for each page. In step S1409, the controller unit 205 determines whether the processes in steps S1403 to S1408 have been executed for all the pages. If it is determined that the processes in steps S1403 to S1408 have been executed for all the pages, the processing shown in FIG. 17 ends.

Next, the processing in a case where it is determined in step S1401 that the print speed information is received from the DFE 103 will be described.

In step S1410, based on the received print speed information, the controller unit 205 sets the print speed to be commonly applied to all the sheets of the job. That is, print speed 1 in the high-speed print mode or print speed 2 in the low-speed print mode is set.

In step S1411, the controller unit 205 analyzes the job data transmitted from the DFE 103. The job data is the job data transmitted from the DFE 103 in step S1305, and includes the information shown in FIG. 16B.

In step S1412, the controller unit 205 applies the print speed set in step S1410, and executes print processing of the sheet of the page of interest.

If the rasterized image data portion 1307 is data formed from a plurality of pages, the processes in steps S1411 and S1412 are repeated for each page. In step S1413, the controller unit 205 determines whether the processes in steps S1411 and S1412 have been executed for all the pages. If it is determined that the processes in steps S1411 and S1412 have been executed for all the pages, the processing shown in FIG. 17 ends.

As described above, according to this embodiment, the DFE 103 creates the job page data (sheet use information) shown in FIG. 13 based on the print job data transmitted from the PC 102 and the information of the medium database acquired from the MFP 101. Then, based on the sheet use information, the DFE 103 decides the print speed not to cause switching of the print speed. After that, the DFE 103 instructs the MFP 101 to start print processing based on the decided print speed. This can suppress lowering of productivity caused by switching of the print speed.

### Second Embodiment

The second embodiment will be described below concerning points different from the first embodiment. In the first embodiment, the DFE 103 decides the print speed based on the sheet use information, and notifies the MFP 101 of the decided print speed information. Then, the MFP 101 executes print processing at the notified print speed. In this embodiment, a DFE 103 transmits created sheet use information to an MFP 101, and the MFP 101 decides a print speed based on the transmitted sheet use information and executes print processing.

FIG. 18 is a flowchart illustrating sheet use information creation processing and job transmission processing to the MFP 101, which are executed by the DFE 103. The processing shown in FIG. 18 is implemented when, for example, a CPU 301 of the DFE 103 reads out a program stored in a ROM 303 into a RAM 302 and executes it.

Steps S1501 to S1506 are the same as steps S1201 to S1206 of FIG. 15 and a description thereof will be omitted.

If it is determined in step S1506 that a print speed optimization mode is set, the CPU 301 transmits, in step S1507, by a network control program 503, job page data (sheet use information) shown in FIG. 13, which has been created in step S1504, to the MFP 101. If it is determined in step S1506 that the print speed optimization mode is not set, the process advances to step S1508. Steps S1508 and S1509 are the same as steps S1304 and S1305 of FIG. 16 and a description thereof will be omitted. After step S1509, the processing shown in FIG. 18 ends.

Next, the operation of the MFP 101 according to this embodiment will be described.

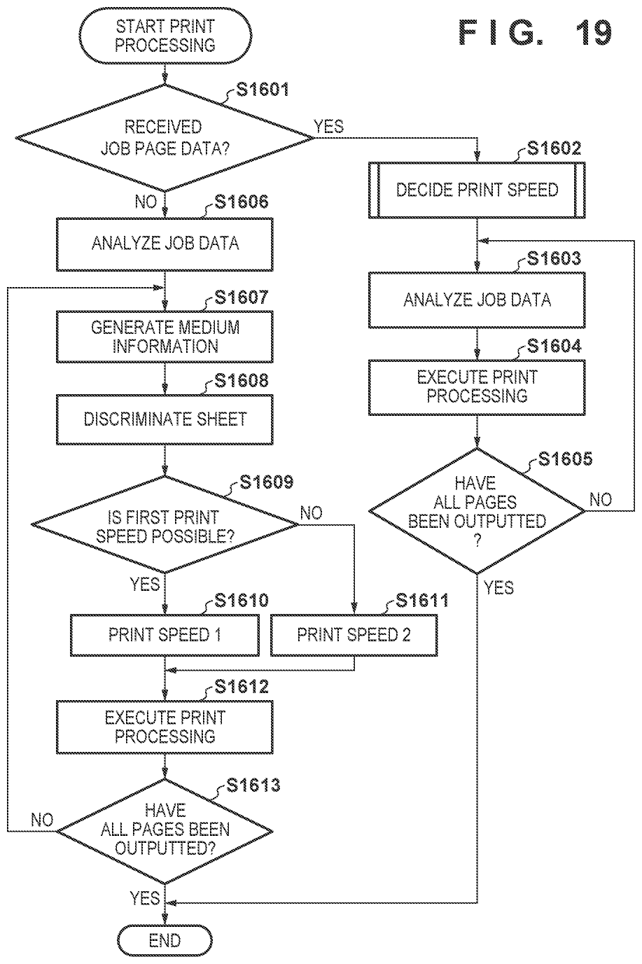

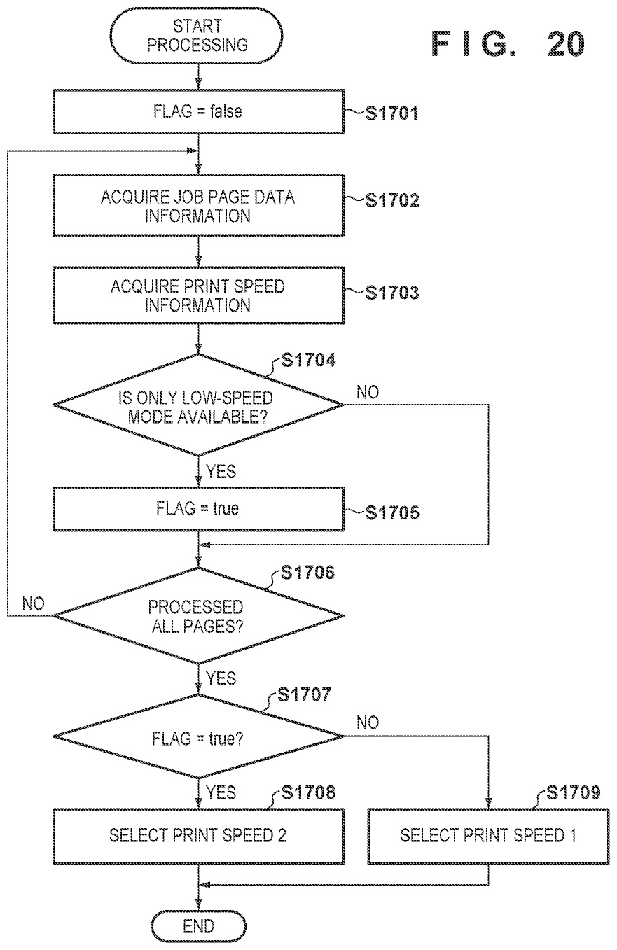

FIGS. 19 and 20 are flowcharts illustrating job print processing in the MFP 101. The processing shown in FIGS. 19 and 20 is implemented when, for example, a controller unit 205 of the MFP 101 reads out a PDL function program 405 from a ROM 207 and executes it.

In step S1601, the controller unit 205 determines whether job page data as sheet use information is received from the DFE 103. The job page data is the job page data transmitted in step S1507 of FIG. 18. If it is determined that the job page data is not received, the process advances to step S1606. From step S1606, print processing shown in FIG. 14A is performed. Steps S1606 to S1613 are the same as steps S1402 to S1409 of FIG. 17 and a description thereof will be omitted. If it is determined that the job page data is received, the process advances to step S1602. From step S1602, the print processing, shown in FIG. 14B, of suppressing the occurrence of switching of the print speed is performed. In step S1602, the controller unit 205 executes processing of deciding the print speed based on the received job page data.

FIG. 20 is a flowchart illustrating the processing of deciding the print speed in step S1602. In step S1701, the controller unit 205 sets the initial value of a print speed selection flag to “false”. In step S1702, the controller unit 205 acquires the job page data. The job page data is the job page data determined in step S1601 to have been received. In step S1703, the controller unit 205 acquires print speed information of the sheet of the page of interest in the job page data.

In step S1704, the controller unit 205 determines whether the sheet used for the page of interest can be printed only in the low-speed print mode. For example, in step S1704, it is determined whether print speed 1 in the high-speed print mode is not available as the print speed mode applicable to the sheet used for the target page. If print speed 1 in the high-speed print mode is not available, only print speed 2 in the low-speed print mode can be applied to the sheet used for the page of interest. Therefore, in this case, in step S1705, the controller unit 205 sets the value of the print speed selection flag to “true”, and advances to step S1706. On the other hand, if it is determined that both the modes can be applied as the print speed mode applicable to the sheet used for the page of interest, the process advances from step S1704 to step S1706. In this case, the value of the print speed selection flag remains “false”.

In step S1706, the controller unit 205 determines whether the processes in steps S1702 to S1705 have been executed for all the pages of the job page data. If it is determined that the processes have not been executed for all the pages, the processes from step S1702 are repeated. If it is determined that the processes have been executed for all the pages, the controller unit 205 determines in step S1707 whether the value of the print speed selection flag is “true”.

If “true” is determined, the controller unit 205 selects and decides, in step S1708, print speed 2 in the low-speed print mode as the print speed common to all the sheets, and then ends the processing shown in FIG. 20. On the other hand, if “true” is not determined, that is, “false” is determined, the controller unit 205 selects and decides, in step S1709, print speed 1 in the high-speed print mode as the print speed common to all the sheets, and then ends the processing shown in FIG. 20.

After the processing shown in FIG. 20, the processes in step S1603 to S1605 are executed. Steps S1603 to S1605 are the same as steps S1411 to S1413 of FIG. 17 and a description thereof will be omitted. As shown in FIG. 20, the print speed decision processing is executed before the start of the processing in step S1603. That is, in this embodiment as well, the print speed decision processing is executed before the start of the processing for the data rasterized into the raster image in step S1603.

As described above, according to this embodiment, the MFP 101 determines the sheet use information received from the DFE 103, and decides the print speed not to cause switching of the print speed based on the result of the determination processing. Then, the MFP 101 executes print processing based on the decided print speed. This can suppress lowering of productivity caused by switching processing of the print speed.

### Third Embodiment

The third embodiment will be described below concerning points different from the first and second embodiments. The first and second embodiments have described the arrangement for deciding the print speed based on the sheet use information of each j ob. This embodiment will describe an arrangement for deciding a print speed based on continuous sheet use information across a plurality of jobs.

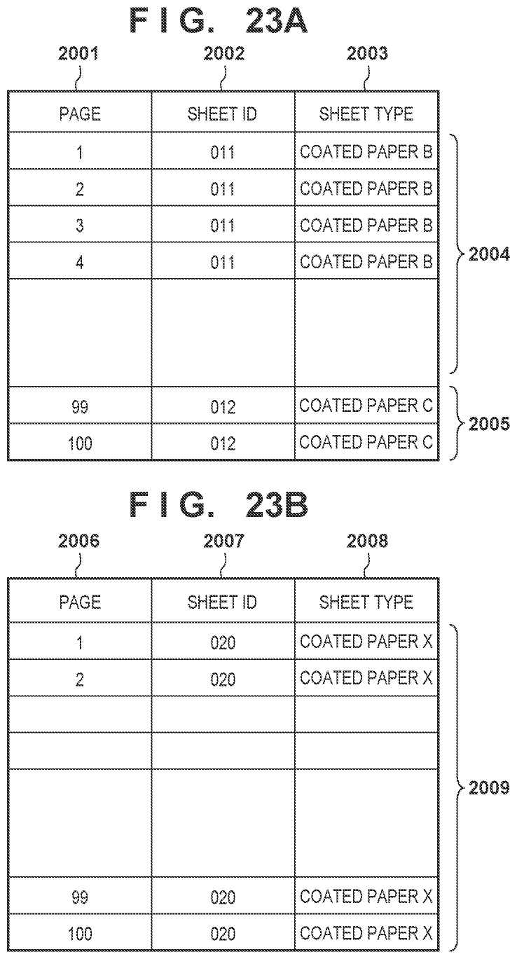

FIGS. 23A and 23B are tables showing two examples of print job data. The structure of each print job data is the same as that shown in FIGS. 10 and 11. Each of page fields 2001 and 2006 indicates page numbers in each print job data shown in each of FIGS. 23A and 23B. Each of sheet ID fields 2002 and 2007 and each of sheet type fields 2003 and 2008 are set for the purpose of being used when printing page data indicated in each of the page fields 2001 and 2006. Each of the sheet ID fields 2002 and 2007 and each of the sheet type fields 2003 and 2008 are fields that store sheet information acquired after the expansion of a PDL data portion 802.

FIGS. 23A and 23B show examples of the print job data in which a mixture of sheet types is set. That is, in the first print job data, a medium 2004 for which the sheet ID is “011” and the sheet type is “coated paper B” is set for pages 1 to 98. Similarly, a medium 2005 for which the sheet ID is “012” and the sheet type is “coated paper C” is set for pages 99 and 100. In the second print job data, a medium 2009 for which the sheet ID is “020” and the sheet type is “coated paper X” is set for pages 1 to 100.

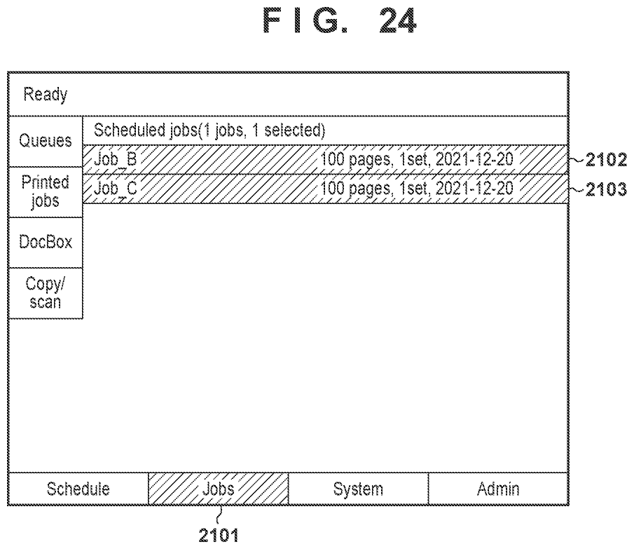

FIG. 24 is a view showing an example of a job management screen displayed on a monitor 105 (or a display unit 310) provided in a DFE 103. FIG. 24 shows a state in which two jobs Job_B 2102 and Job_C 2103 are registered in the DFE 103 in a state in which a job management screen selection portion 2101 is selected.

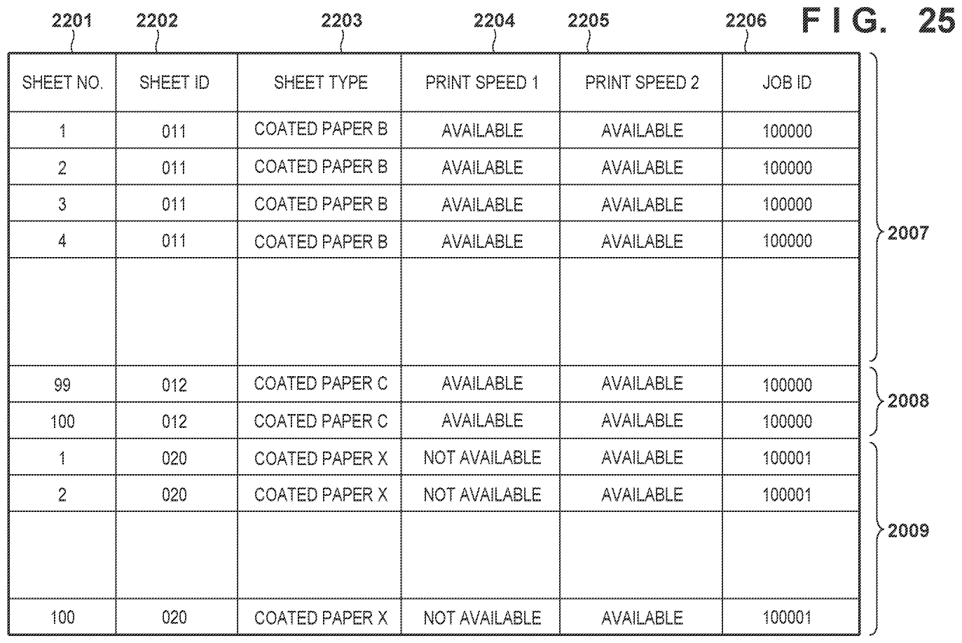

FIG. 25 is a table showing an example of job page data (sheet use information) generated and managed in the DFE 103 to determine a print speed to be applied at the time of continuously printing the two jobs Job_B 2102 and Job_C 2103 shown in FIG. 24.

The job page data shown in FIG. 25 is formed from a plurality of fields. The information shown in FIG. 25 can be obtained when the DFE 103 receives and analyzes, by a network control program 503, information of a medium database shown in FIG. 6 managed by a medium management program 406 of an MFP 101.

With respect to each page indicated by a page field 2201, sheet information used at the time of printing is represented by a sheet ID field 2202 and a sheet type field 2203. Furthermore, with respect to a sheet used at the time of printing each page, a print speed field 2204 and a print speed field 2205 indicate whether print speed 1 in a high-speed print mode and print speed 2 in a low-speed print mode can be applied, respectively. A job ID field 2206 is identification information for identifying each job.

As shown in FIG. 25, values in the print speed field 2204 and the print speed field 2205 are both “available” for pages 1 to 100 of the first job (job ID: 100000). On the other hand, the value in the print speed field 2204 is “not available” and the value in the print speed field 2205 is “available” for pages 1 to 100 of the second job (job ID: 100001).

That is, if the DFE 103 receives the two print job data shown in FIGS. 23A and 23B, it is determined that the sheet types selected at the time of continuously printing the two print job data include a sheet printable only at print speed 2. In other words, it is determined that print processing at print speed 1 in the high-speed print mode can be performed for pages 1 to 100 of the first job. However, it is necessary to execute printing only at print speed 2 in the low-speed print mode when printing sheets for pages 1 to 100 of the subsequent second job. Therefore, switching of the print speed from print speed 1 to print speed 2 occurs, and the switching time is added to the print processing time.

In this embodiment, even at the time of continuously printing a plurality of jobs, it is possible to suppress lowering of productivity caused by the occurrence of the switching time by performing the following processing.

In this embodiment, as an example, assume that the print sheet size of the print job Job_B 2102 is A4, and print speed 1 in the high-speed print mode of the print speed modes of the MFP 101 is 100 PPM. In addition, the total number of pages of the print job data is 100 and the number of print sheets is 100. Furthermore, as an example, assume that the print sheet size of the print job Job_C 2103 is A4, and print speed 2 in the low-speed print mode of the print speed modes of the MFP 101 is 75 PPM. In addition, the total number of pages of the print job data is 100 and the number of print sheets is 100.

Then, if the print jobs Job_B 2102 and Job_C 2103 are printed as continuous sheets, the print sheet size of the print jobs is A4, and print speed 1 in the high-speed print mode of the print speed modes of the MFP 101 is 100 PPM. Furthermore, print speed 2 in the low-speed print mode is 75 PPM. It takes 30 sec to switch between print speed 1 and print speed 2. The total number of pages of the print job data is 200, and the number of print sheets is 200.

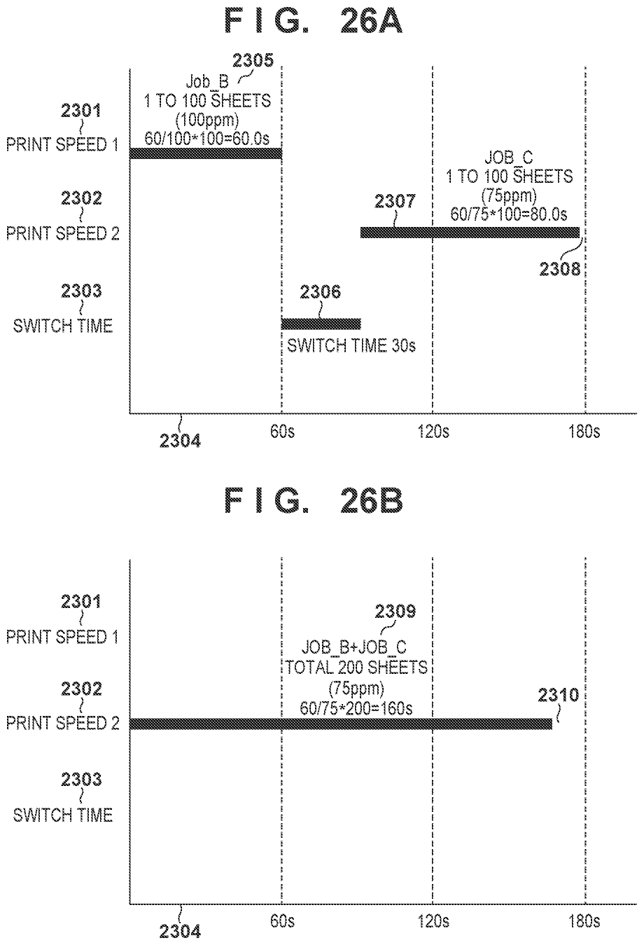

FIG. 26A is a timing chart for explaining a case where the MFP 101 executes conventional print processing of each of the print jobs Job_B 2102 and Job_C 2103 using the above conditions. FIG. 26A shows required times at print speeds applied to pages at the time of printing, and a switching time in a case where switching of the print speed occurs. The ordinate represents the required time at a print speed 2301 (print speed 1), the required time at a print speed 2302 (print speed 2), and a switching time 2303. An abscissa 2304 represents accumulation of required times from the start of processing.

As shown in FIG. 26A, media for which print processing at print speed 1 can be performed are used for pages 1 to 100 of the print job Job_B 2102. Processing is performed in the high-speed print mode at 100 PPM, and a required time 2305 is 60.0 sec. On the other hand, for the media of pages 1 to 100 of the print job Job_C 2103, print processing at print speed 1 cannot be performed, and only print processing at print speed 2 can be performed. For this reason, switching processing of the print speed occurs, and a switching time 2306 of 30.0 sec is required. After the switching processing is ended, print processing of pages from the first page of the print job Job_C 2103 is executed, and a required time 2307 is 80.0 sec. Thus, a cumulative time 2308 is 170.0 sec.

FIG. 26B shows a case where the print jobs Job_B 2102 and Job_C 2103 are processed as a group of continuous sheets using the above conditions according to this embodiment. FIG. 26B also shows required times at print speeds applied to pages at the time of printing and a switching time in a case where switching of the print speed occurs when the MFP 101 executes print processing. If all the sheets are printed commonly using print speed 2 as the print speed to be applied at the time of printing in order to suppress the occurrence of a switching time of the print speed mode, a required time 2309 is 160.0 sec. Thus, a cumulative time 2310 is 160.0 sec. As a result, with respect to the print job data shown in each of FIGS. 23A and 23B, the productivity is improved by 10.0 sec by suppressing the occurrence of switching of the print speed mode.

As described above, in this embodiment, the DFE 103 decides the print speed not to cause switching processing of the print speed based on the continuous sheet use information across the plurality of jobs. Then, the DFE 103 can instruct the MFP 101 to start print processing based on the decided print speed. This can suppress lowering of productivity caused by switching of the print speed.

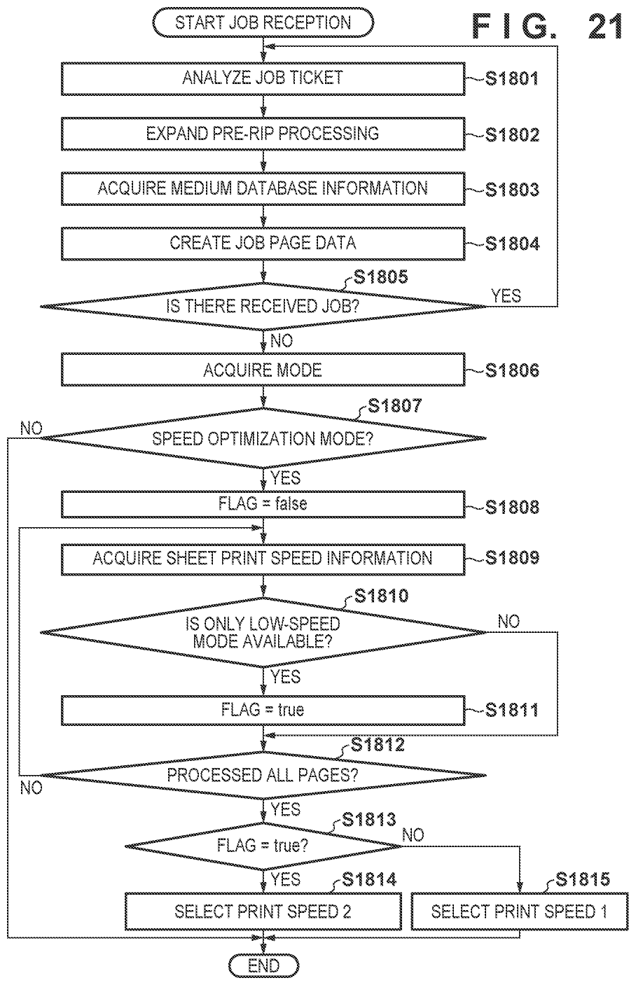

FIG. 21 is a flowchart illustrating print control processing according to this embodiment. The processing shown in FIG. 21 is implemented when, for example, a CPU 301 of the DFE 103 reads out a program stored in a ROM 303 into a RAM 302 and executes it. The processing shown in FIG. 21 is started when an optimization designation portion 708 shown in FIG. 9 is selected and the DFE 103 receives a plurality of print job data from a PC 102 via the network control program 503.

Steps S1801 to S1803 are the same as steps S1201 to S1203 of FIG. 15 and a description thereof will be omitted.

In step S1804, the CPU 301 creates, by a job management program 504, the job page data shown in FIG. 25 based on the medium information of the print job data shown in FIGS. 23A and 23B and the information of the medium database shown in FIG. 6. The CPU 301 can determine the mixture state of the set contents in the print speed field 2204 (print speed 1) and the print speed field 2205 (print speed 2) from the created job page data.

In step S1805, the CPU 301 determines, by the job management program 504, whether there is received next print job data. If it is determined that there is the received next job, the processes from step S1801 are repeated. That is, by repeating the processes in steps S1801 to S1804, the job page data shown in FIG. 25, as the continuous sheet use information across the plurality of jobs, is created. If it is determined in step S1805 that there is no received next job, the process advances to step S1806. Steps S1806 to S1808 are the same as steps S1206 to S1208 of FIG. 15 and a description thereof will be omitted.

In step S1809, the CPU 301 pays attention to one page in the print job data, and acquires print speed information of a sheet used for the page of interest from the print speed field 2204 and the print speed field 2205 of the job page data in FIG. 25. Then, in step S1810, the CPU 301 determines whether the sheet used for the page of interest can be printed only in the low-speed print mode. For example, in step S1810, it is determined whether print speed 1 in the high-speed print mode is not available as the print speed mode applicable to the sheet used for the page of interest. If print speed 1 in the high-speed print mode is not available, only print speed 2 in the low-speed print mode can be applied to the sheet used for the page of interest. Therefore, in this case, in step S1811, the CPU 301 sets the value of a print speed selection flag to “true”, and advances to step S1812. On the other hand, if it is determined that both the modes can be applied as the print speed mode applicable to the sheet used for the page of interest, the process advances from step S1810 to step S1812. In this case, the value of the print speed selection flag remains “false”.

In step S1812, the CPU 301 determines whether the processes in steps S1809 to S1811 have been executed for all the target pages of the print job data across the plurality of jobs. If it is determined that the processes have not been executed for all the pages, the processes from step S1809 are repeated. If it is determined that the processes have been executed for all the pages, the CPU 301 determines in step S1813 whether the value of the print speed selection flag is “true”.

If “true” is determined, the CPU 301 selects, in step S1814, print speed 2 in the low-speed print mode as the print speed to be commonly used for all the sheets of the plurality of jobs, and then ends the processing shown in FIG. 21. On the other hand, if “true” is not determined, that is, “false” is determined, the CPU 301 selects, in step S1815, print speed 1 in the high-speed print mode as the print speed to be commonly used for all the sheets of the plurality of jobs, and then ends the processing shown in FIG. 21.

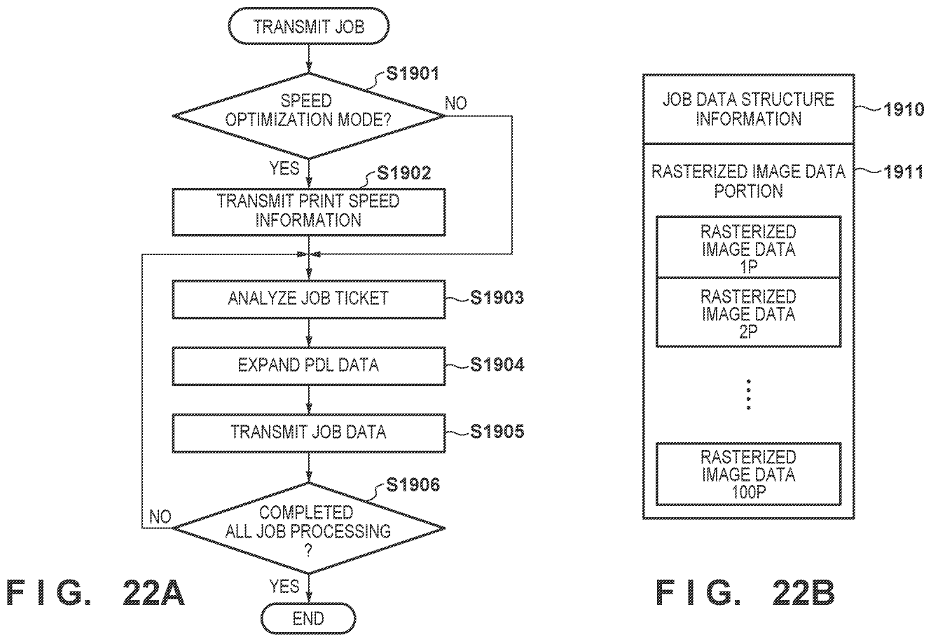

FIG. 22A is a flowchart illustrating job transmission processing in the DFE 103. The processing shown in FIG. 22A is implemented when, for example, the CPU 301 of the DFE 103 reads out a program stored in the ROM 303 into the RAM 302 and executes it. For example, the processing shown in FIG. 22A is executed after the processing shown in FIG. 21.

In step S1901, the CPU 301 determines, based on the set value of the optimization designation portion 708 acquired in step S1806, whether a print speed optimization mode of optimizing the print speed is set. If it is determined that the print speed optimization mode is set, the CPU 301 transmits, in step S1902, by the network control program 503, print speed information (information representing print speed 1 or print speed 2) decided in FIG. 21 to the MFP 101. Note that print speed 1 designated in the print speed information is the print speed in the high-speed print mode corresponding to a print speed field 606 in the medium database managed by the medium management program 406 of the MFP 101. Print speed 2 is the print speed in the low-speed print mode corresponding to the print speed field 607 in the medium database. After step S1902, the process advances to step S1903. If it is determined in step S1901 that the print speed optimization mode is not set, the process advances to step S1903.

In step S1903, the CPU 301 analyzes the contents of a job ticket portion 801 in the print job data. Then, the CPU 301 creates, based on the analysis result, job data structure information including setting information applied to the entire job, the number of pages and the page size of the print job data, sheet information of each page, various kinds of setting information, and information of each post-processing. Then, in step S1904, the CPU 301 starts expansion processing of the PDL data portion 802. The expansion processing in step S1904 includes processing of interpreting PDL data and rasterizing the data into a raster image.

In step S1905, the CPU 301 transmits, by the job management program 504, the job data shown in FIG. 22B including job data structure information 1910 and a rasterized image data portion 1911 to the MFP 101. FIG. 22B is a view showing the data having undergone the processes in steps S1903 and S1904. The job data structure information 1910 and the rasterized image data portion 1911 are the same as the job data structure information 1306 and the rasterized image data portion 1307 shown in FIG. 16, respectively, and a description thereof will be omitted.

In step S1906, the CPU 301 determines, by the job management program 504, whether transmission processing of all the received jobs in FIG. 21 is complete. If it is determined that the transmission processing of all the jobs is complete, the processing shown in FIG. 22 ends. If it is determined that the transmission processing of all the jobs is not complete, the processes from step S1903 are repeated.

As described above, according to this embodiment, the DFE 103 decides the print speed not to cause switching processing of the print speed based on the continuous sheet use information across the plurality of jobs. Then, the DFE 103 instructs the MFP 101 to start print processing based on the decided print speed. This can suppress lowering of productivity caused by switching of the print speed even in a case where the MFP 101 continuously executes the plurality of jobs.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2022-165021, filed Oct. 13, 2022, which is hereby incorporated by reference herein in its entirety.

What is claimed is:

1. A controlling apparatus comprising:
at least one memory and at least one processor which function as:
an acquisition unit configured to acquire sheet information of each of a plurality of pages included in job data for executing print processing in a printing apparatus;
a decision unit configured to decide a print speed in the print processing based on the sheet information acquired by the acquisition unit; and
a control unit configured to control the printing apparatus based on the print speed decided by the decision unit and data generated from the job data and processible by the printing apparatus,
wherein even in a case where sheet types represented by the pieces of sheet information are mixed in the plurality of pages, the decision unit decides a print speed to be commonly applied to the sheet types of the plurality of pages.

2. The apparatus according to claim 1, wherein based on sheet information acquired by the acquisition unit from job data of each of a plurality of jobs, the decision unit decides a print speed to be commonly applied to the plurality of jobs.

3. The apparatus according to claim 2, wherein the plurality of jobs are continuously executed in the printing apparatus.

4. The apparatus according to claim 1, wherein the controlling apparatus is an apparatus outside the printing apparatus.

5. The apparatus according to claim 4, wherein the controlling apparatus is a Digital Font End (DFE).

6. The apparatus according to claim 4, further comprising a reception unit configured to receive the job data,
wherein the acquisition unit acquires the sheet information of each of the plurality of pages included in the job data received by the reception unit.

7. The apparatus according to claim 6, wherein the job data is Page Description Language (PDL) data.

8. The apparatus according to claim 7, further comprising a conversion unit configured to convert, after the decision unit decides the print speed, the job data into data processible by the printing apparatus,
wherein the control unit transmits, to the printing apparatus, the print speed decided by the decision unit and the data generated by the conversion by the conversion unit and processible by the printing apparatus.

9. The apparatus according to claim 8, wherein the data processible by the printing apparatus is data rasterized into a raster image.

10. The apparatus according to claim 1, wherein the sheet information includes information for associating a sheet type and applicability of each of a plurality of print speeds with each other.

11. The apparatus according to claim 1, wherein the decision unit decides a print speed in the print processing from a plurality of print speeds including at least a first print speed and a second print speed lower than the first print speed.

12. The apparatus according to claim 11, wherein in a case where the sheet information of each of the plurality of pages acquired by the acquisition unit indicates that the first print speed is applicable, the control unit decides the first print speed as the print speed in the print processing.

13. The apparatus according to claim 11, wherein in a case where the pieces of sheet information of the plurality of pages acquired by the acquisition unit include information indicating that the first print speed is not applicable, the control unit decides the second print speed as the print speed in the print processing.

14. The apparatus according to claim 1, wherein in a case where an acceptance unit accepts designation of executing a job in a predetermined mode, the decision unit decides the print speed in the print processing.

15. The apparatus according to claim 14, wherein in a case where the acceptance unit does not accept the designation of executing the job in the predetermined mode, the decision unit does not decide the print speed in the print processing, and the control unit controls the printing apparatus based on the data generated from the job data and processible by the printing apparatus.

16. The apparatus according to claim 15, wherein the predetermined mode is a productivity priority mode.

17. The apparatus according to claim 16, wherein the case where the acceptance unit does not accept the designation of executing the job in the predetermined mode includes a case where the acceptance unit does not accept designation of executing the job in a quality priority mode.

18. A control method executed in a controlling apparatus, comprising:
acquiring sheet information of each of a plurality of pages included in job data for executing print processing in a printing apparatus;
deciding a print speed in the print processing based on the acquired sheet information; and
controlling the printing apparatus based on the decided print speed and data generated from the job data and processible by the printing apparatus,
wherein even in a case where sheet types represented by the pieces of sheet information are mixed in the plurality of pages, a print speed to be commonly applied to the sheet types of the plurality of pages is decided.

19. A non-transitory computer-readable storage medium storing a program configured to cause a computer to function to:
acquire sheet information of each of a plurality of pages included in job data for executing print processing in a printing apparatus;
decide a print speed in the print processing based on the acquired sheet information; and
control the printing apparatus based on the decided print speed and data generated from the job data and processible by the printing apparatus,
wherein even in a case where sheet types represented by the pieces of sheet information are mixed in the plurality of pages, a print speed to be commonly applied to the sheet types of the plurality of pages is decided.
